(19) United States
(12) Patent Application Publication
(10) Pub. No.: US 2015/0055623 A1
(43) Pub. Date: Feb. 26, 2015

(54) MOBILE SOFTWARE DEFINED NETWORKING (MobiSDN)

(71) Applicant: Samsung Electronics Co., Ltd., Suwon-si (KR)

(72) Inventors: Ying Li, Richardson, TX (US); Mian Dong, Houston, TX (US); Howon Choe, Richardson, TX (US); Thomas David Novlan, Dallas, TX (US); Jianzhong Zhang, Plano, TX (US); Glenn Morrow, Royse City, TX (US)

(21) Appl. No.: 14/468,255

(22) Filed: Aug. 25, 2014

Related U.S. Application Data
(60) Provisional application No. 61/869,524, filed on Aug. 23, 2013.

(51) Int. Cl. H04W 40/04; H04L 12/721; H04W 36/00

(52) U.S. Cl. CPC H04W 40/04; H04W 36/0011; H04L 45/566
USPC 370/331; 370/329

(57) ABSTRACT

A method and apparatus for managing data in a software defined network. The apparatus is configured to receive control information related to a source node and a target node from a plurality of network devices in the software defined network. The apparatus is also configured to identify a route for data forwarding between the source node and the target node based on the control information. The apparatus is also configured to request data forwarding to the plurality of network devices according to the route. The source node or the target node can be at least one of a user equipment (UE), and a cellsite node including at least a base station.

### CROSS-REFERENCE TO RELATED APPLICATION(S) AND CLAIM OF PRIORITY

The present application claims priority to U.S. Provisional Patent Application Ser. No. 61/869,524, filed Aug. 23, 2013, entitled “MOBILE SOFTWARE DEFINED NETWORKING (MobiSDN)”. The content of the above-identified patent document is incorporated herein by reference.

### TECHNICAL FIELD

The present application relates generally to a mobile software defined network and, more specifically, to a smart edge controller in a mobile software defined network.

### BACKGROUND

Cellular networks consist of Radio Access Network (RAN) which operates with the air interface of the base stations (referred to as evolved NodeBs (eNBs)) and mobile stations (referred to as User Equipments (UEs)) where an eNB can consist of one or multiple cells, and Evolved Packet Core (EPC) network which operates with the packet processing after the eNB before it goes to the Internet. The explosive increase in demand for wireless data has placed increasing challenges on today's RAN and EPC which both have limitations.

The demand of wireless data traffic is explosively increasing. At the meantime, operators are facing one of their biggest problems, which is to manage the network in an optimal way. The growing popularity of smart phones and tablet computers places an increasing strain on wireless networks, however, despite tremendous innovation in mobile applications, the wireless network infrastructure such as in the cellular networks is remarkably brittle.

Centralizing data-plane functions, such as monitoring, access control, and quality-of-service functionality at the P-GW introduces scalability challenges. This makes the equipment very expensive (e.g., more than 6 million dollars for a Cisco P-GW). Centralizing data-plane functions at the cellular-Internet boundary forces all traffic through the P-GW, including traffic between users on the same cellular network, making it difficult to host popular content inside the cellular network. In addition, the network equipment has vendor-specific configuration interfaces, and communicates through complex control-plane protocols, with a large and growing number of tunable parameters (e.g., several thousand parameters for base stations). As such, carriers have (at best) indirect control over the operation of their networks, with little ability to create innovative services.

### SUMMARY

One or more embodiments provide an apparatus for managing data in a software defined network. The apparatus comprising a memory element and a controller. The controller is configured to receive control information related to a source node and a target node from a plurality of network devices in the software defined network. The controller is also configured to identify a route for data forwarding between the source node and the target node based on the control information. The controller is also configured to request data forwarding to the plurality of network devices according to the route. The source node or the target node can be at least one of a user equipment (UE), and a cellsite node including at least a base station.

One or more embodiments provide an apparatus for managing data in a software defined network. The apparatus comprising a base station, a cellsite server, and a controller. The controller is configured to receive data packets from a source node. The controller is also configured to perform deep packet inspection on the data packets to identify control information. The controller is also configured to send the control information to an edge controller in the software defined network. The controller is also configured to receive routing information from the edge controller. The controller is also configured to forward the data packets based on the routing information

One or more embodiments provide a method for managing data in a software defined network. The method includes receiving control information related to a source node and a target node from a plurality of network devices in the software defined network. The method also includes identifying a route for data forwarding between the source node and the target node based on the control information. The method also includes requesting data forwarding to the plurality of network devices according to the route. The source node or the target node can be at least one of a user equipment (UE), and a cellsite node including at least a base station.

One or more embodiments provide a method for managing data in a software defined network. The method includes receiving data packets from a source node. The method also includes performing deep packet inspection on the data packets to identify control information. The method also includes sending the control information to an edge controller in the software defined network. The method also includes receiving routing information from the edge controller. The method also includes forwarding the data packets based on the routing information

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an overview of the architecture of cellular networks which consist of Radio Access Network (RAN) and Evolved Packet Core (EPC) network according to an embodiment of this disclosure;

FIG. 2 illustrates a computing system according to an embodiment of this disclosure;

FIG. 3 illustrates a client device according to an embodiment of this disclosure;

FIG. 4A illustrates a diagram of a MobiSDN 400 according to an embodiment of this disclosure;

FIG. 4B illustrates a block diagram of a MobiSDN controller 410 according to an embodiment of this disclosure;

FIG. 4C illustrates a block diagram of a MobiSDN switch 435 according to an embodiment of this disclosure;

FIG. 4D illustrates a block diagram of a Cellsite (eNB) server 442 according to an embodiment of this disclosure;

FIG. 4E illustrates a block diagram of a Cellsite (eNB) (referred to as Cellsite node) with MobiSDN capability 474 according to an embodiment of this disclosure;

FIG. 4F illustrates a block diagram of a Cellsite (eNB) 480 (referred to as cellsite node) with MobiSDN capability, as an edge controller, according to an embodiment of this disclosure;

FIG. 4G illustrates a block diagram of a MobiSDN network 481, according to an embodiment of this disclosure;

FIG. 4H illustrates a block diagram of a MobiSDN network 482, according to an embodiment of this disclosure;

FIG. 4I illustrates a block diagram of a MobiSDN network 483, according to an embodiment of this disclosure;

FIG. 4J illustrates a block diagram of a MobiSDN network 484, according to an embodiment of this disclosure;

FIG. 5A illustrates a block diagram of a MobiSDN 500A according to an embodiment of this disclosure;

FIG. 5B illustrates a block diagram of a MobiSDN 500B according to an embodiment of this disclosure;

FIG. 6 illustrates a diagram of smart overlay networks 600 for CDN and real-time application according to an embodiment of this disclosure;

FIG. 7 illustrates a system using an edge server to reduce the content provision latency according to an embodiment of this disclosure;

FIG. 8 illustrates a system using MobiSDN for CDN, where edge node (eNB, or WiFi, etc.) can coordinate content according to an embodiment of this disclosure;

FIG. 9 illustrates a system using MobiSDN for CDN, where a cache server can coordinate content according to an embodiment of this disclosure;

FIG. 10 illustrates a sequence flow using MobiSDN for CDN, where a cache server can coordinate content according to an embodiment of this disclosure;

FIG. 11 illustrates a system using MobiSDN for CDN when a UE hands over according to an embodiment of this disclosure;

FIG. 12 illustrates a sequence flow using SDN for CDN when UE hands over according to an embodiment of this disclosure;

FIG. 13 illustrates a QoE management system and content distribution controller according to an embodiment of this disclosure;

FIG. 14 illustrates a system using MobiSDN for using an edge server to reduce the visual search latency according to an embodiment of this disclosure;

FIG. 15 illustrates a system using MobiSDN for visual search, where edge node (eNB, or WiFi, etc.) can coordinate a search according to an embodiment of this disclosure;

FIG. 16 illustrates a system using MobiSDN for visual search, where a visual search server can coordinate a search according to an embodiment of this disclosure;

FIG. 17 illustrates a sequence flow using MobiSDN for visual search, where a visual search server can coordinate a search according to an embodiment of this disclosure;

FIG. 18 illustrates a sequence flow using MobiSDN for visual search when UE hands over according to an embodiment of this disclosure;

FIG. 19 illustrates a QoE management system and augmented reality controller according to an embodiment of this disclosure;

FIG. 20 illustrates a system using virtualization in MobiSDN according to an embodiment of this disclosure;

FIG. 21 illustrates a sequence flow using virtualization in MobiSDN with cell-site SDN controller according to an embodiment of this disclosure;

FIG. 22 illustrates a system using virtualization in MobiSDN for online gaming according to an embodiment of this disclosure;

FIG. 23 illustrates a sequence flow using virtualization in MobiSDN for online gaming with a cell-site SDN controller according to an embodiment of this disclosure;

FIG. 24 illustrates a system using virtualization in MobiSDN for localized service according to an embodiment of this disclosure;

FIG. 25 illustrates a sequence flow using virtualization in MobiSDN for localized service with a cell-site SDN controller according to an embodiment of this disclosure;

FIG. 26 illustrates a system using MobiSDN with a UE handover from one eNB to another eNB and a UE handover from eNB to WiFi node via SDN switches according to an embodiment of this disclosure;

FIG. 27 illustrates a sequence flow of UE handover from Node1 to Node2 via SDN switches according to an embodiment of this disclosure;

FIG. 28 illustrates a system of a SDN-based connectivity controller according to an embodiment of this disclosure;

FIG. 29 illustrates a system of real-time analytics according to an embodiment of this disclosure;

FIG. 30 illustrates a system for caching with a SDN according to an embodiment of this disclosure;

FIG. 31 illustrates a system for caching with a SDN according to an embodiment of this disclosure; and

FIG. 32 illustrates a protocol stack according to an embodiment of this disclosure.

### DETAILED DESCRIPTION

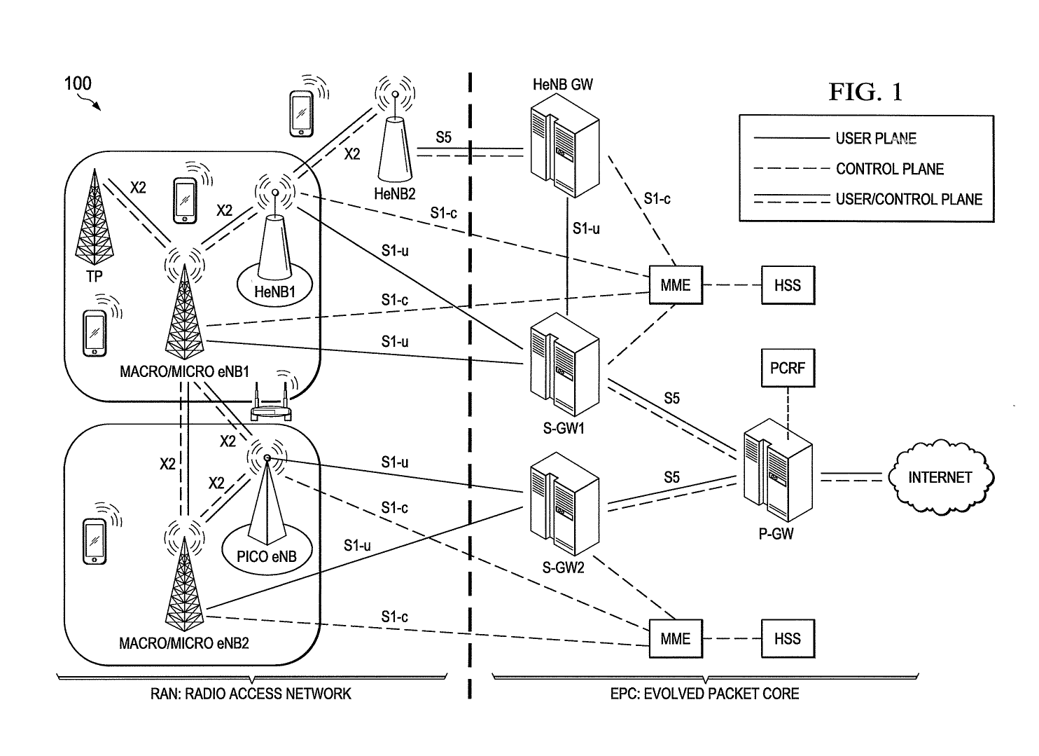

FIGS. 1 through 32, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or method.

FIG. 1 illustrates an overview 100 of the architecture of cellular networks which consist of Radio Access Network (RAN) and Evolved Packet Core (EPC) network according to an embodiment of this disclosure. RAN mainly deals with air interface of the base stations (referred to as evolved NodeBs (eNBs)) and mobile stations (referred to as User Equipments (UEs)) where an eNB can consist of one or multiple cells. EPC mainly deals the packet processing after the eNB before it goes to the Internet.

RAN and EPC are interfaced via S-interface, mostly S1-interface. In FIG. 1, X2 is mainly the interface in-between eNBs, or in-between transmit point (TP) and eNB. S1 is the interface in-between RAN and EPC (S1-c stands for S1 interface control plane, which is for control path. S1-u stands for S1 interface user plane, which is for data path). S5 is the interface in-between gateways, or in-between home eNB and home eNB gateway.

In an embodiment, RAN can deploy heterogeneous networks. Cells with different sizes can be used in a hierarchical network deployment, referred to as multi-tier deployment or multi-tier networks, where each tier can be for one type of cells of certain size. The type and location of the eNB controlling these cells will play a significant role in determining the cost and performance of the multi-tier deployments. For example, indoor femto-cell deployments using home eNBs (HeNBs) can utilize the existing back-haul thereby significantly lowering the cost of such deployments. With outdoor pico-cell deployments through pico eNB, the operator will need to provide back-haul capability and manage more critical spectrum reuse challenges. Other deployment models cover indoor enterprise or outdoor campus deployments that may impose different manageability and reliability requirements.

The RAN part of FIG. 1 illustrates an exemplary heterogeneous network with macro/micro eNB, pico eNB, and a femto-cell/HeNB. For the heterogeneous network shown in FIG. 1 the pico eNB has smaller transmission power than macro eNB, hence with smaller coverage than the macro eNB. On the other hand, the HeNB can have smaller transmission power than a pico eNB. A cell formed by a TP can belong to an eNB. Pico-cells typically are managed together with macro/micro cells by operators. An interface of X2 can be used for the communications among the eNBs, HeNBs and TPs. All kinds of eNBs can be connected to Service GateWay (S-GW) in EPC for the user plane (or the data plane), and connected to Mobility Management Entity (MME) in EPC for the control plane. For HeNB, it can also be connected to the S-GW and MME via a HeNB gateway. It is noted that FIG. 1 does not include relay eNB for simplicity. Relay eNB can be included where an eNB who does not have wired backhaul can connect to the EPC via a relay eNB.

The coverage area of the pico-cell is not only limited by its transmit power, but also to a large extent by the inter-cell interference from other cells. Therefore, if the cell selection criteria are only based on downlink UE measurements such as reference signal received power (RSRP), only UEs in the close vicinity will end up being served by the pico eNB. Due to the higher deployment density of the small cells, it is beneficial to expand the footprint of the pico cells, i.e., offloading UEs from-macro cells to pico-cells, to enable more UEs to connect to the small cells to take advantage of the higher deployment density. This can be achieved through cell range expansion (RE). One of the approaches for cell range expansion is that a cell-specific bias to the UE measurement of X dB is applied for pico eNB to favor connecting to it. In this way, more UEs will be inclined to connect to pico eNBs instead of macro eNBs. Furthermore, time domain inter-cell interference coordination techniques can also be utilized for pico users which are served at the edge of the serving pico cell, for example, for traffic off-loading from a macro cell to a pico cell.

Spectrum allocation across multiple tiers is an aspect of deployment and use of hierarchical architectures. According to the spectrum used, multi-tier cell deployments are possible for the following cases.

In a multiple carrier case, the multi-tier cells are deployed on multiple carriers. When multiple carriers are available, choices can be made to enable flexible cell deployment. For example, the macro-cell and small cells can be deployed on distinct carriers, or on the same set of carriers while having joint carrier and power assignment/selection to better manage inter-cell interference. In a single carrier case, the multi-tier cells are deployed on a single carrier. This can also be called as co-channel deployment.

Techniques such as carrier aggregation (CA) and Coordinated Multi-Point (CoMP) can apply for the resource management. Muting in the time domain can also apply. CoMP transmissions can be used to coordinate the transmissions among multiple cells such as a joint transmission from multiple points to achieve higher system performance.

A UE can be connected to multiple cells, such as in CA case, or in CoMP case. A UE may concurrently connect to more than one eNBs, such as in dual connectivity case. The coordinated cells, or the cells or eNBs that the UE connects to may have ideal backhaul or non-ideal backhaul.

Cellular networks connect eNBs to the Internet using IP networking equipment. An illustration of the entities in EPC and how they connect to each other is shown in the EPC part of FIG. 1.

For the data plane or the user plane, the traffic from an eNB goes through a Serving GateWay (S-GW) over a tunnel. The S-GW serves as a local mobility anchor that enables seamless communication when the user moves from one base station to another. The S-GW must handle frequent changes in a user's location, and store a large amount of state since users retain their IP addresses when they move. The S-GW tunnels traffic to the P-GW. The P-GW enforces quality-of-service policies and monitors traffic to perform billing. The P-GW also connects to the Internet and other cellular data networks, and acts as a firewall that blocks unwanted traffic. The policies at the P-GW can be very fine-grained, based on whether the user is roaming, properties of the user equipment, usage caps in the service contract, parental controls, and so on.

Besides data-plane functionalities, the eNB, S-GW, and P-GW also participate in several control-plane protocols. In coordination with the MME, they perform hop-by-hop signaling to handle session setup, teardown, band reconfiguration, as well as mobility, e.g., location update, paging, and handoff. For example, in response to a UE's request for dedicated session setup (e.g., for VoIP call), the P-GW sends QoS and other session information (e.g., the TCP/IP 5-tuple) to the S-GW. The S-GW in turn forwards the information to the MME. The MME then asks the eNB to allocate radio resources and establish the connection to the UE. During handoff of a UE, the source eNB sends the handoff request to the target eNB. After receiving an acknowledgement, the source eNB transfers the UE state (e.g., buffered packets) to the target eNB. The target eNB also informs the MME that the UE has changed cells, and the previous eNB to release resources.

The S-GW and P-GW are also involved in routing protocols. The Policy Control and Charging Function (PCRF) manages flow-based charging in the P-GW. The PCRF is connected to the P-GW via control interface. The PCRF also provides the QoS authorization (QoS class identifier and bit rates) that decides how to treat each traffic flow, based on the user's subscription profile. QoS policies can be dynamic, e.g., based on time of day. This must be enforced at the P-GW. The Home Subscriber Server (HSS) contains subscription information for each user, such as the QoS profile, any access restrictions for roaming, and the associated MME. The HSS is connected to the MME via control interface. In times of cell congestion, a base station reduces the max rate allowed for subscribers according to their profiles, in coordination with the P-GW.

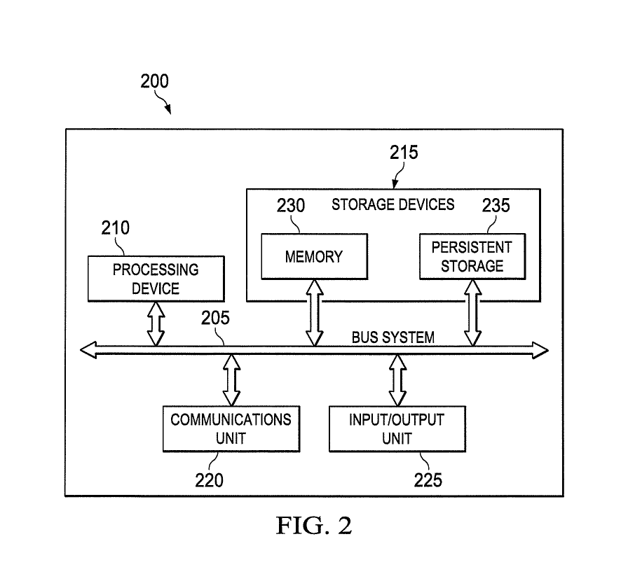

FIG. 2 illustrates a computing system 200 according to an embodiment of this disclosure. As shown in FIG. 2, the computing system 200 includes a bus system 205, which supports communication between at least one processing device 210, at least one storage device 215, at least one communications unit 220, and at least one input/output (I/O) unit 225.

The processing device 210 executes instructions that may be loaded into a memory 230. The processing device 210 may include any suitable number(s) and type(s) of processors or other devices in any suitable arrangement. Example types of processing devices 210 include microprocessors, microcontrollers, digital signal processors, field programmable gate arrays, application specific integrated circuits, and discreet circuitry.

The memory 230 and a persistent storage 235 are examples of storage devices 215, which represent any structure(s) capable of storing and facilitating retrieval of information (such as data, program code, and/or other suitable information on a temporary or permanent basis). The memory 230 may represent a random access memory or any other suitable volatile or non-volatile storage device(s). The persistent storage 235 may contain one or more components or devices supporting longer-term storage of data, such as a ready only memory, hard drive, Flash memory, or optical disc.

The communications unit 220 supports communications with other systems or devices. For example, the communications unit 220 could include a network interface card or a wireless transceiver facilitating communications over the network 102. The communications unit 220 may support communications through any suitable physical or wireless communication link(s).

The I/O unit 225 allows for input and output of data. For example, the I/O unit 225 may provide a connection for user input through a keyboard, mouse, keypad, touchscreen, or other suitable input device. The I/O unit 225 may also send output to a display, printer, or other suitable output device.

Note that while FIG. 2 is described as representing any of the devices of FIG. 1, the same or similar structure could be used in one or more other devices. For example, an edge controller, a laptop or desktop computer could have the same or similar structure as that shown in FIG. 2.

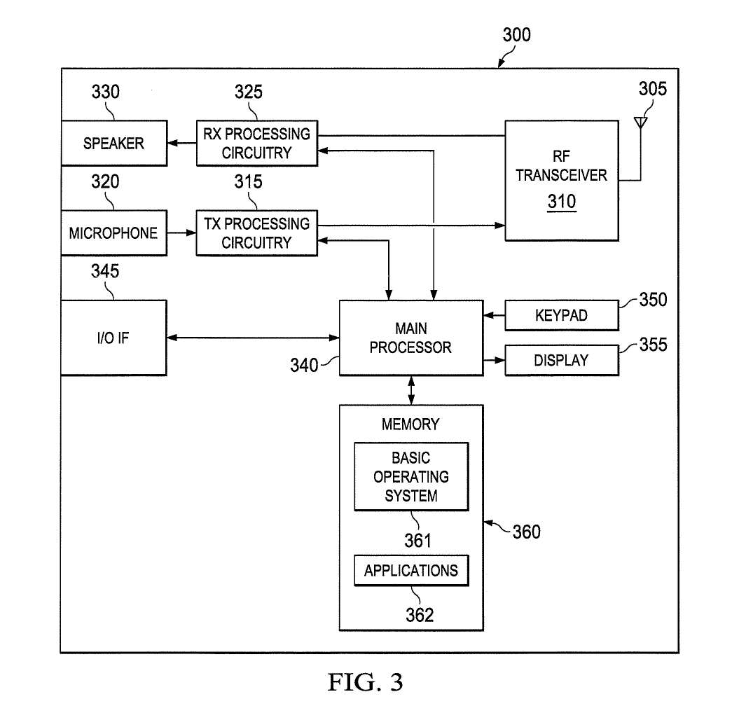

FIG. 3 illustrates a client device 300 according to an embodiment of this disclosure. As shown in FIG. 3, the client device 300 includes an antenna 305, a radio frequency (RF) transceiver 310, transmit (TX) processing circuitry 315, a microphone 320, and receive (RX) processing circuitry 325. The client device 300 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by another component in a system. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the client device 300. For example, the main processor 340 could control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360. The main processor 340 can move data into or out of the memory 360 as required by an executing process. In some embodiments, the main processor 340 is configured to execute the applications 362 based on the OS program 361 or in response to signals received from external devices or an operator. The main processor 340 is also coupled to the I/O interface 345, which provides the client device 300 with the ability to connect to other devices such as laptop computers and handheld computers. The I/O interface 345 is the communication path between these accessories and the main processor 340.

The main processor 340 is also coupled to the keypad 350 and the display unit 355. The operator of the client device 300 can use the keypad 350 to enter data into the client device 300. The display 355 may be a liquid crystal display or other display capable of rendering text and/or at least limited graphics, such as from web sites.

The memory 360 is coupled to the main processor 340. Part of the memory 360 could include a random access memory (RAM), and another part of the memory 360 could include a Flash memory or other read-only memory (ROM).

Although FIGS. 2 and 3 illustrate examples of devices in a computing system, various changes may be made to FIGS. 2 and 3. For example, various components in FIGS. 2 and 3 could be combined, further subdivided, or omitted and additional components could be added according to particular needs. As a particular example, the main processor 340 could be divided into multiple processors, such as one or more central processing units (CPUs) and one or more graphics processing units (GPUs). Also, while FIG. 3 illustrates the client device 300 configured as a mobile telephone or smartphone, client devices could be configured to operate as other types of mobile or stationary devices. In addition, as with computing and communication networks, client devices and servers can come in a wide variety of configurations, and FIGS. 2 and 3 do not limit this disclosure to any particular client device or computing system.

One or more embodiments of this disclosure recognize and take into account that the growing popularity of smart phones and tablet computers places an increasing strain on wireless networks, however, despite tremendous innovation in mobile applications, the wireless network infrastructure such as in the cellular networks is remarkably brittle. The explosive increase in demand for wireless data traffic has created opportunities for the next generation wireless network architectures incorporating Software defined networking (SDN). Support for SDN is gaining momentum in wired networks, because of their potential advantages such as low cost deployments, easy management, flexible traffic flow and routing, traffic offloading, add-on services and revenue-adding services, and the capability to deliver services to mobile stations which require large amount of data. However, SDN has not yet been studied much for wireless networks, especially in the consideration of aspect such as supporting many subscribers, frequent mobility, fine-grained measurement and control, and real-time adaptation introduces scalability challenges that future SDN architectures should address. This disclosure provides solutions for mobile software defined networks/networking (MobiSDN).

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In one embodiment, mobile software defined networks/networking (MobiSDN) architecture is considered. MobileSDN is a network including wireless links, where the control plane of the network is physically separate from the forwarding plane. Network intelligence is (logically) centralized in software-based SDN controllers, which maintain a global view of the network. The network appears to the application and policy engines as a single, logical switch.

In MobiSDN, there are MobiSDN capable base stations. To further develop smart edge solution with good services, networking base stations using MobiSDN can be developed, to achieve more business targets. With MobiSDN, good use cases for revenue adding, or to help operators to have good value adding services can be developed.

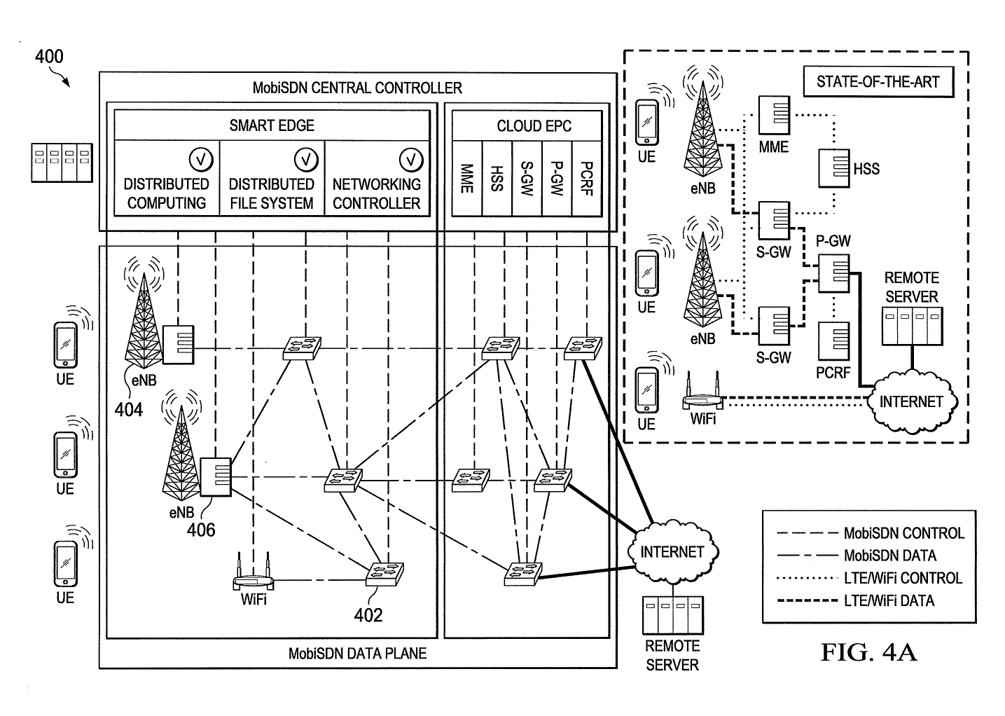

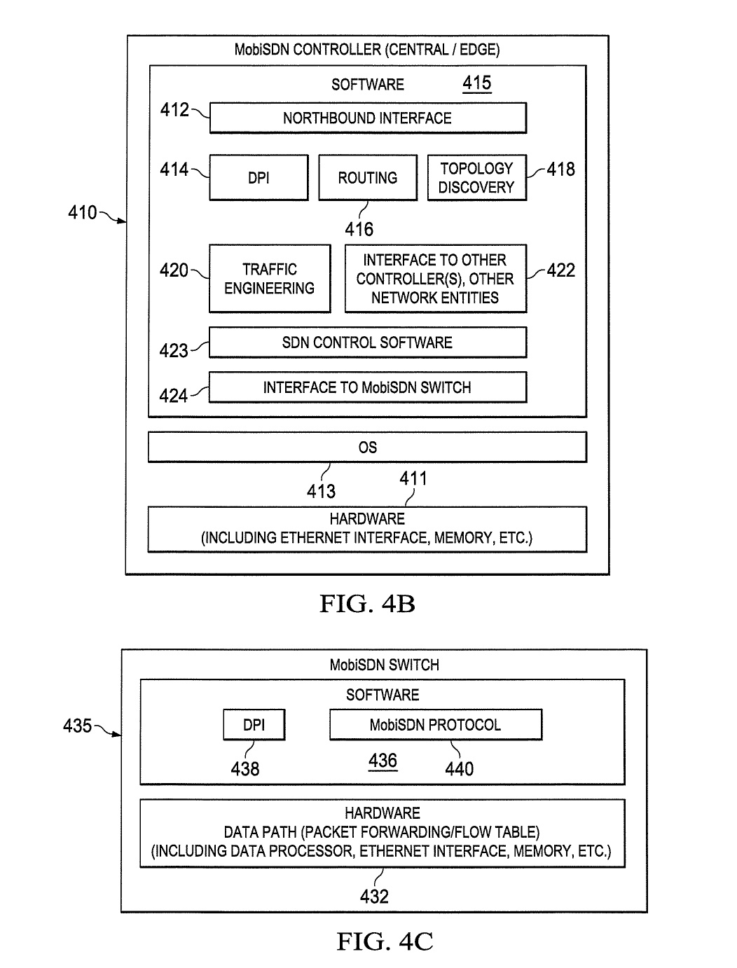

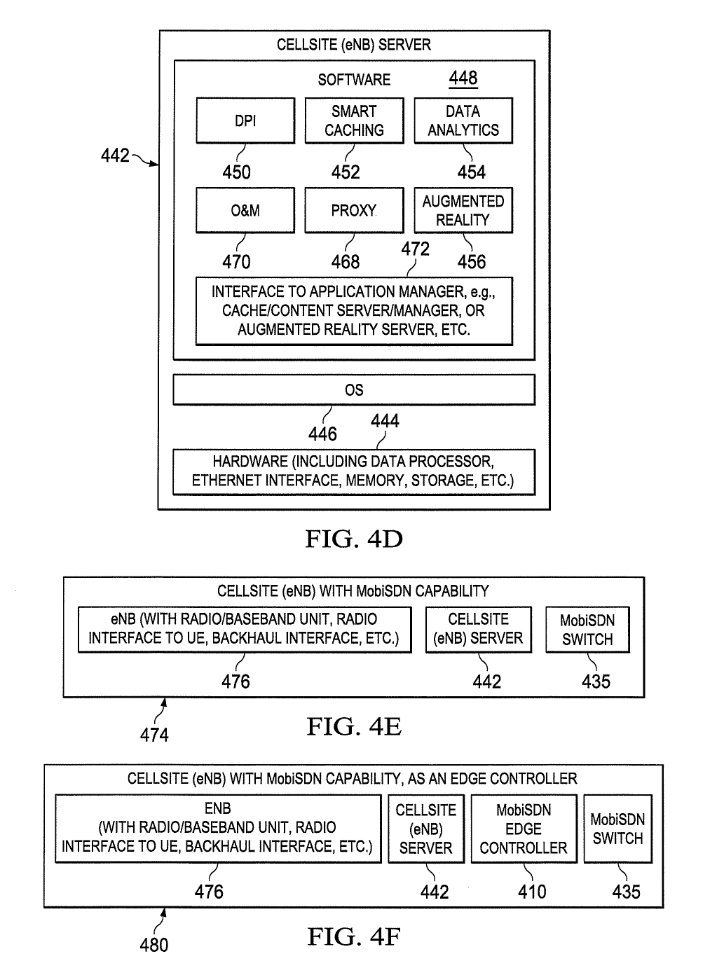

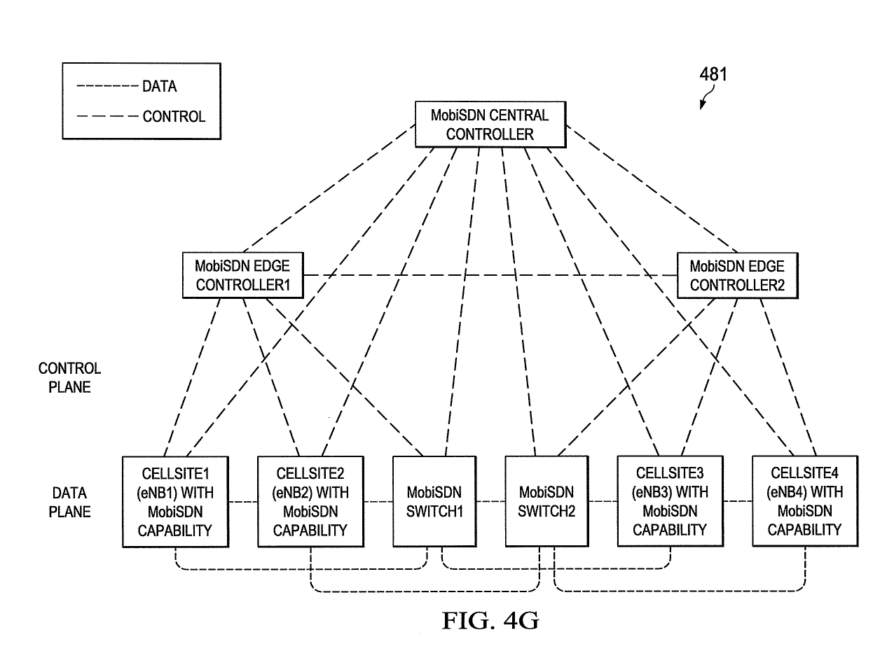

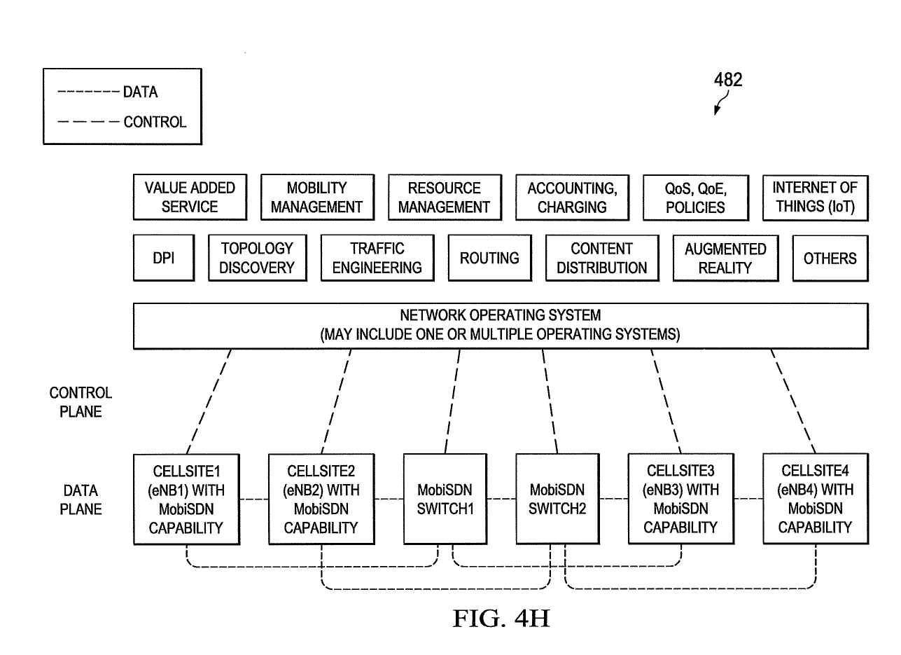

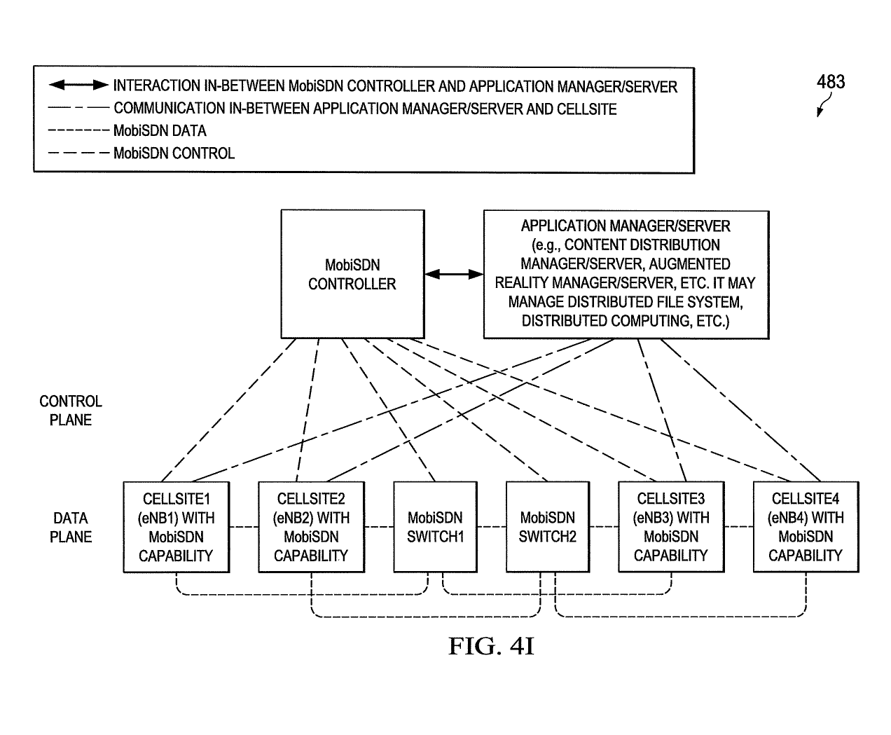

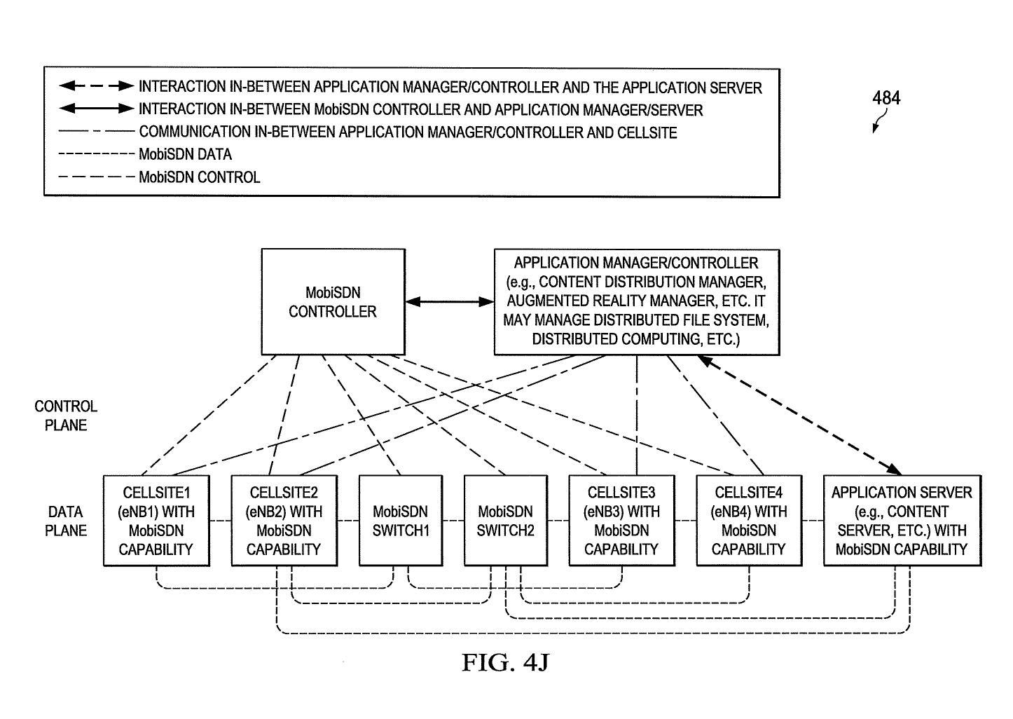

FIG. 4A illustrates a diagram of a MobiSDN 400 according to an embodiment of this disclosure. The MobiSDN 400 has a smart edge and a cloud EPC. The central controller and data plane are following SDN architecture, with SDN switches 402, eNBs 404, and servers 406 as the hardware. The embodiment of the MobiSDN 400 shown in FIG. 4 is for illustration only. Other embodiments of a MobiSDN could be used without departing from the scope of the present disclosure.

The smart edge has SDN capable eNBs. The edge controller is also SDN based and its function can be part of the central controller. Edge server can sit aside the eNB.

In one example embodiment, the smart edge has three main functions: distributed computing, distributed file system, and networking controller. The distributed computing is for computing at the edge, with computing load balancing, programming transparency. The distributed file system can support distributed storage, cache sharing, content search, and the like. The network controller is based on SDN with programmable routers, with flexible policy check and is friendly to middle box. These functions are inevitable and needed, considering the big mobile data and huge mobile video traffic demand.

For the smart edge, it may be also referred to as edge SDN, or cell-site SDN. The edge controller may also be referred to as cell-site SDN controller, or smart edge SDN controller. The smart edge controller can be a separate entity besides the central SDN controller, and it communicates with central SDN controller, or the smart edge controller can be viewed as part of the central controller. In a network, there can be one or multiple of smart edge controllers and these controllers may communicate with each other.

The cloud EPC is SDN capable. It has SDN switches and servers as the hardware. It can have the functions including the functions provided by Mobility Management Element (MME), Home Subscriber Server (HSS), Serving Gateway) (S-GW), Packet Data Network Gateway (P-GW), Policy Control and Charging Function (PCRF), etc. These functions can be applied to each of the SDN switches. The switches are also involved in routing, running protocols.

In one or more embodiment, examples of the functions provided by MME, HSS, S-GW, P-GW, PCRF, and the like, are shown below.

The S-GW serves as a local mobility anchor that enables seamless communication when the user moves from one base station to another. The S-GW handles frequent changes in a user's location, and store a large amount of state since users retain their IP addresses when they move. The P-GW enforces quality-of-service policies and monitors traffic to perform billing. The P-GW also connects to the Internet and other cellular data networks, and acts as a firewall that blocks unwanted traffic. The policies at the P-GW can be very fine-grained, based on whether the user is roaming, properties of the user equipment, usage caps in the service contract, parental controls, and so on. These are the data plane functions and they can be applied to switches.

Besides data plane functions, the control plane functions can be for the cloud EPC and they can be part of the central controller. In coordination with the MME, session setup, teardown, and reconfiguration, as well as mobility e.g., location update, paging, and handoff can be performed. For example, in response to a UE's request for dedicated session setup (e.g., for VoIP call), the P-GW sends QoS and other session information (e.g., the TCP/IP 5-tuple) to the S-GW. The S-GW in turn forwards the information to the MME. The MME then asks the base station to allocate radio resources and establish the connection to the UE. During handoff of a UE, the source base station sends the handoff request to the target base station. After receiving an acknowledgement, the source base station transfers the UE state (e.g., buffered packets) to the target base station. The target base station also informs the MME that the UE has changed cells, and the previous base station to release resources. The PCRF manages flow-based charging. The PCRF also provides the QoS authorization (QoS class identifier and bit rates) that decides how to treat each traffic flow, based on the user's subscription profile. QoS policies can be dynamic, e.g. based on time of day. The Home Subscriber Server (HSS) contains subscription information for each user, such as the QoS profile, any access restrictions for roaming, and the associated MME. In times of cell congestion, a base station reduces the max rate allowed for subscribers according to their profiles.

Although here the functions in data and control plane are described by using the names of MME, HSS, S-GW, P-GW, PCRF, etc., there may or may not be these network elements any more. For example, MME, PCRF, HSS can be absorbed in the SDN central controller, while some of the functions of S-GW and P-GW will be in the data plane (e.g., the SDN switches) and some will be in the control plane (absorbed in the SDN central controller).

The following figure illustrates an example of the architecture of MobiSDN.

In FIG. 4A, the MobiSDN central controller includes the smart edge functions including distributed computing, distributed file system, and networking controller, and cloud EPC control functions including MME, HSS, S-GW, P-GW, etc. In MobiSDN data plane, the SDN switches can forward data. In the edge, user equipment (UE) can connect to a base station (eNodeB, eNB), or a WiFi node, where eNB and WiFi nodes have the radio hardware. Some of the SDN switches (for example, the OpenFlow switch, or the switch supporting OpenFlow) can connect to Internet to which a remote server is also connected. Note that the control plane and the data plane are physically separated, where the switches in the data plane are mainly for the data forwarding, and the central controller has the intelligence of controlling the routing, policy control, charging, mobility, resource management, etc.

In FIG. 4A, the state-of-the-art is also shown. Long Term Evolution (LTE) cellular networks connect eNBs to the Internet using IP networking equipment. The UE connects to a base station, which directs traffic through S-GW over a GPRS Tunneling Protocol (GTP) tunnel. The S-GW tunnels traffic to the P-GW. The P-GW also connects to the Internet and other cellular data networks, and acts as a firewall that blocks unwanted traffic. In coordination with the MME, they perform hop-by-hop signaling to handle session setup, tear-down, and reconfiguration, as well as mobility e.g., location update, paging, and handoff. The S-GW and P-GW are also involved in routing, running protocols such as OSPF. The PCRF manages flow-based charging in the P-GW. The HSS contains subscription information for each user, such as the QoS profile, any access restrictions for roaming, and the associated MME. WiFi node can be connected to the Internet through its interface, such as Ethernet port, cable, DSL, etc.

It is essentially different comparing MobiSDN with the state-of-the-art architecture. MobiSDN has clear separation of data plane and control plane. MobiSDN is also very flat, contrasting to the P-GW which can be the bottleneck as the node connecting to the Internet in the state of the art.

The disclosure uses eNB or WiFi as the exemplary node as the node in the smart edge, however, it is not limited to just eNB or WiFi, rather, other type of the nodes can also apply, such as Bluetooth, visible light communications, etc. The disclosure uses UE to edge node such as eNB or WiFi communication as the exemplary end-user communication with the node in the edge, however, it is not limited to such, rather, it can also apply to UE to UE (or device to device) communications.

The applications for MobiSDN, as examples, include Super CDN, Super visual search, Virtualization for value-adding services, such as online gaming, video conferencing, document collaboration, query processing, machine to machine communication (M2M), Internet of Things (IoT), local broadcasting (example: stadium), and efficient mobility.

FIG. 4B illustrates a block diagram of a MobiSDN controller 410 according to an embodiment of this disclosure. The embodiment of the MobiSDN controller 410 in FIG. 4B is for illustration only. Other embodiments of the system could be used without departing from the scope of the present disclosure. Throughout the disclosure, unless otherwise mentioned, the MobiSDN controller 410 can be interchangeable to SDN controller.

In an embodiment, the MobiSDN controller 410 can be a central controller, or an edge controller, or a controller in other scale than being a central or edge, such as a regional controller. The MobiSDN controller 410 can have hardware 411 which may include Ethernet interface, memory, and the like. The hardware could be for example, items similar to those of computing system 200 as shown in FIG. 2. The communication module may be wired or wireless, such as wired backhaul, or wireless backhaul. The MobiSDN controller 410 can have operating system (OS) 413 as well as software modules.

The software 415 can include a northbound interface 412, which interfaces the upper layer. The software can include deep packet inspection (DPI) function 414, routing function 416, network topology discovery function 418, traffic engineering function 420, an interface to other controller(s) (such as other MobiSDN controllers at edge, center, region, etc.), or other network entities 422 (such as other application controller or manager), SDN control software 423, and/or an interface to MobiSDN switch 424 (such as MobiSDN switch itself, or other network entities which can have MobiSDN capability (e.g., comprising a MobiSDN switch)). The software 415 may also include other functions. Throughout the disclosure, unless otherwise mentioned, the MobiSDN capability can be interchangeable to SDN capability.

FIG. 4C illustrates a block diagram of a MobiSDN switch 435 according to an embodiment of this disclosure. The embodiment of the MobiSDN switch 435 in FIG. 4C is for illustration only. Other embodiments of the system could be used without departing from the scope of the present disclosure. Throughout the disclosure, unless otherwise mentioned, the MobiSDN switch 435 can be interchangeable to SDN switch. The MobiSDN switch 435 may be one example of switch 402 as shown in FIG. 4A.

In an embodiment, the MobiSDN switch 435 can have hardware 432 which can be used for data/packet forwarding on a data path, with flow table. Throughout the disclosure, unless otherwise mentioned, data forwarding can be interchangeable to packet forwarding, data packet forwarding. The hardware 432 may include data processor(s), Ethernet interface (which can interface to the other entities in the data plane, such as other switches, eNBs, servers, etc.), memory, and the like. The hardware could be for example, items similar to those of computing system 200 as shown in FIG. 2. The MobiSDN switch 435 may have embedded OS (not shown in the figure) as well as software modules. The software 436 can include a DPI function 438, a MobiSDN protocol module 440 which can interface to the MobiSDN controller. The software 436 may also include other functions.

FIG. 4D illustrates a block diagram of a Cellsite (eNB) server 442 according to an embodiment of this disclosure. The embodiment of the Cellsite (eNB) server 442 in FIG. 4D is for illustration only. Other embodiments of the system could be used without departing from the scope of the present disclosure. The Cellsite (eNB) server 442 may be one example of servers 406 as shown in FIG. 4A.

In an embodiment, the Cellsite (eNB) server 442 can have hardware 444 which may include data processor(s), Ethernet interface (which can interface to the other entities in the data plane, such as other switches, eNBs, servers, etc.), memory, storage, and the like. The hardware could be for example, items similar to those of computing system 200 as shown in FIG. 2. The Cellsite (eNB) server 442 may have operating system (OS) 446 as well as software modules. The software 448 can include functions or applications such as DPI function 450, smart caching 452, data analytics 454 such as analytics to retrieve contexts, augmented reality 456, proxy support 468, operations and maintenance (O&M) 470, and the like. The software 448 may include an interface 472 to application manager, or application server, such as cache or content server or manager, or augmented reality server or manager, and the like. The software may also include other functions.

FIG. 4E illustrates a block diagram of a Cellsite (eNB) (referred to as Cellsite node) with MobiSDN capability 474 according to an embodiment of this disclosure. The embodiment of the Cellsite (eNB) 474 with MobiSDN capability in FIG. 4E is for illustration only. Other embodiments of the system could be used without departing from the scope of the present disclosure. The Cellsite (eNB) with MobiSDN capability 474 may be one example of eNBs 404 as shown in FIG. 4A.

In an embodiment, the Cellsite (eNB) with MobiSDN capability 474 can have an eNB 476, which can have radio unit and baseband unit, radio interface to UE, and backhaul interface to other network node, and others such as other hardware and software. The Cellsite (eNB) with MobiSDN capability 474 can include a MobiSDN switch 435, such as in FIG. 4C. It may include Cellsite (eNB) server 442, such as in FIG. 4D. These three elements (eNB, Cellsite (eNB) server, MobiSDN switch) can be co-located at the cell site, or they can be integrated as a whole or some of them can be integrated (for example, MobiSDN switch may be integrated with the Cellsite (eNB) server). In an embodiment, the Cellsite (eNB) server may be omitted, and then the Cellsite (eNB) with MobiSDN capability 474 includes an eNB and the MobeSDN switch 435. The Cellsite node may use X2 interface to communicate to other eNBs, and use Ethernet interface to communicate to SDN switches.

FIG. 4F illustrates a block diagram of a Cellsite (eNB) 480 (referred to as cellsite node) with MobiSDN capability, as an edge controller, according to an embodiment of this disclosure. The embodiment of the Cellsite (eNB) 480 with MobiSDN capability as an edge controller in FIG. 4F is for illustration only. Other embodiments of the system could be used without departing from the scope of the present disclosure.

In an embodiment, the Cellsite (eNB) 480 with MobiSDN capability as an edge controller can have Cellsite (eNB) 474 with MobiSDN capability such as in FIG. 4E, as well as it can have MobiSDN edge controller 410 such as in FIG. 4B. The Cellsite (eNB) 480 with MobiSDN capability as an edge controller can have functionality as an edge controller, where it may control other nodes, such as other eNBs. These four elements (eNB, Cellsite (eNB) server, MobiSDN switch, MobiSDN edge controller) can be co-located at the cell site, or they can be integrated (for example, any two of the Cellsite (eNB) server, MobiSDN switch and MobiSDN edge controller can be integrated, or three of them can be integrated, or all these four can be integrated). In an embodiment, the element Cellsite (eNB) server may be omitted, and then the Cellsite (eNB) 480 with MobiSDN capability consists of an eNB, the MobeSDN switch 435, and the MobiSDN edge controller 410. Throughout the disclosure, eNB and cellsite node can be interchangeable, unless otherwise mentioned.

FIG. 4G illustrates a block diagram of a MobiSDN network 481, according to an embodiment of this disclosure. The embodiment of the MobiSDN network 481 in FIG. 4G is for illustration only. Other embodiments of the system could be used without departing from the scope of the present disclosure.

In an example embodiment, Cellsite1, Cellsite2, Cellsite3, Cellsite4, MobiSDN switch1, MobiSDN switch2 can have data plane, where the data can be forwarded among them. MobiSDN edge controller1 has control plane connectivity with Cellsite1, Cellsite2, MobiSDN switch1. MobiSDN edge controller2 has control plane connectivity with Cellsite3, Cellsite4, MobiSDN switch2. MobeSDN central controller can have control plane connectivity with MobiSDN edge controller1, MobiSDN edge controller2, and all the Cellsites and MobiSDN switches.

In an example embodiment, some of the control plane connectivity may be omitted, for example, the control in-between MobiSDN cental controller and Cellsite4 can be omitted. Cellsite1, Cellsite2, MobiSDN switch1 can form a slice and the slice can be controlled by MobiSDN edge controller1, while the MobiSDN edge controller1 may talk to MobiSDN central controller. The MobiSDN edge controller1 may also talk to other edge controllers if needed. In an embodiment, the edge controllers may be omitted, and instead, there can be a central controller. In an embodiment, an eNB may not include SDN switch or SDN switch functions; hence the eNB may not be MobiSDN capable. Such eNB may not connect to the SDN controller in the control plane, but rather the eNB can be connected with a SDN switch and the switch is connected to the SDN controller in the control plane.

FIG. 4H illustrates a block diagram of a MobiSDN network 482, according to an embodiment of this disclosure. The embodiment of the MobiSDN network 482 in FIG. 4H is for illustration only. Other embodiments of the system could be used without departing from the scope of the present disclosure.

In an example embodiment, Cellsite1, Cellsite2, Cellsite3, Cellsite4, MobiSDN switch1, MobiSDN switch2 can have data plane, where the data can be forwarded among them. Cellsites and switches can be connected to the control plane, such as a MobiSDN controller, such as MobiSDN controller as shown in FIG. 4B. The controller can be viewed as a network operating system and functions supported on the network operation system. The network operating system may include one or multiple operating systems. Functions and applications can be supported, such as DPI, topology discovery, traffic engineering, routing, content distribution, augmented reality, Internet of Things (IoT), value added services, mobility management, resource management (such as interference management, cell ON/OFF management, radio link management, and so on), accounting, charging for services, quality of service (QoS), quality of experience (QoE) provisioning, policy controls, and others. In an embodiment, an eNB may not include SDN switch or SDN switch functions; hence the eNB may not be MobiSDN capable. Such eNB may not connect to the SDN controller in the control plane, rather, the eNB can be connected with a SDN switch and the switch is connected to the SDN controller in the control plane.

FIG. 4I illustrates a block diagram of an example MobiSDN network 483, according to an embodiment of this disclosure. The embodiment of the MobiSDN network 483 in FIG. 4I is for illustration only. Other embodiments of the system could be used without departing from the scope of the present disclosure.

In an example embodiment, Cellsite1, Cellsite2, Cellsite3, Cellsite4, MobiSDN switch1, MobiSDN switch2 can have data plane, where the data can be forwarded among them. Cellsites and switches can be connected to a MobiSDN controller, such as MobiSDN controller as shown in FIG. 4B. The MobiSDN controller can interact with an application manager/server, for example, a content distribution manager/server, an augmented reality manager/server, etc. The application manager/server may manage distributed file system, distributed computing, etc. Cellsite1, Cellsite2, Cellsite3, Cellsite4 can be connected to the application manager or server, using the control plane. For example, at cellsites, local content caching can be supported, and each local content caching can be managed by a content distribution manager, or a caching manager, or a caching server, which may manage a distributed file system (DFS).

In an example embodiment, when the cellsites local content server or local content cache is updated, the manager can update the DFS. The manager knows which portion (for example, segments) of the content is located in which local content server, and it can interact with MobiSDN controller, which may have the traffic engineering and routing function, to figure out the best route to deliver certain content to a node, considering the route availability, content availability, efficiency, latency, and so on. In an embodiment, an eNB may not include SDN switch or SDN switch functions; hence the eNB may not be MobiSDN capable. Such eNB may not connect to the SDN controller in the control plane, rather, the eNB can be connected with a SDN switch and the switch is connected to the SDN controller in the control plane.

FIG. 4J illustrates a block diagram of a MobiSDN network 484, according to an embodiment of this disclosure. The embodiment of the MobiSDN network 484 in FIG. 4J is for illustration only. Other embodiments of the system could be used without departing from the scope of the present disclosure.

In an embodiment, Cellsite1, Cellsite2, Cellsite3, Cellsite4, MobiSDN switch1, MobiSDN switch 2, application server (such as content server, etc.) with MobiSDN capability can have data plane, where the data can be forwarded among them. The application server with MobiSDN capability can be of similar structure as the one as the Cellsite (eNB) server as in FIG. 4D, while the application server may be of more storage or higher capability in computing or search. Cellsites (eNBs), switches, and the application server can be connected to a MobiSDN controller, such as MobiSDN controller as shown in FIG. 4B. The MobiSDN controller can interact with an application manager/controller, for example, a content distribution manager, an augmented reality manager, and the like. The application manager/controller may manage distributed file system, distributed computing, and the like.

In an example embodiment, Cellsite1, Cellsite2, Cellsite3, Cellsite4, the application server, can be connected to the application manager or controller, using the control plane. The application server on the data plane and the application manager/controller may be co-located, or integrated as one entity (for example, the box of application server on the data plane and the application controller can be part of an entity of an application server, where the former on the data plane of the application server, and the latter on the control plane of the application server).

The MobiSDN controller may be an edge controller, or regional controller, or central controller. The MobiSDN controller may be co-located with the application controller, or may be integrated with the application manager/controller. The application server, the application manager/controller, the MobiSDN controller may be co-located, or may be integrated. For example, at cellsites, local content caching can be supported, and each local content caching can be managed by a content distribution manager, or a caching manager, which may manage a DFS.

The content manager may be the control plane of a content server, where the content server can have data plane or the data forwarding function, connected to the SDN controller. When the cellsites local content server or local content cache is updated, or when the content in the content server is updated, the manager can update the DFS. The DFS includes the file system on the local content servers (cellsites (eNBs) servers), and the content application server. The manager knows which portion (for example, segments) of the content is located in which content server, and it can interact with MobiSDN controller, which may have the traffic engineering and routing function, such that the SDN controller can figure out the best route (for example, lowest latency, or lowest traffic load, etc.) to deliver certain content to a node, considering the route availability, content availability, efficiency, latency, and so on. The SDN controller can determine the routing, and request SDN switch to forward the request to the source server (server at the cellsites, or content server) via SDN switches. The source server can send content via path/route determined by the SDN controller. In an embodiment, an eNB may not include SDN switch or SDN switch functions; hence the eNB may not be MobiSDN capable. Such eNB may not connect to the SDN controller in the control plane, rather, the eNB can be connected with a SDN switch and the switch is connected to the SDN controller in the control plane.

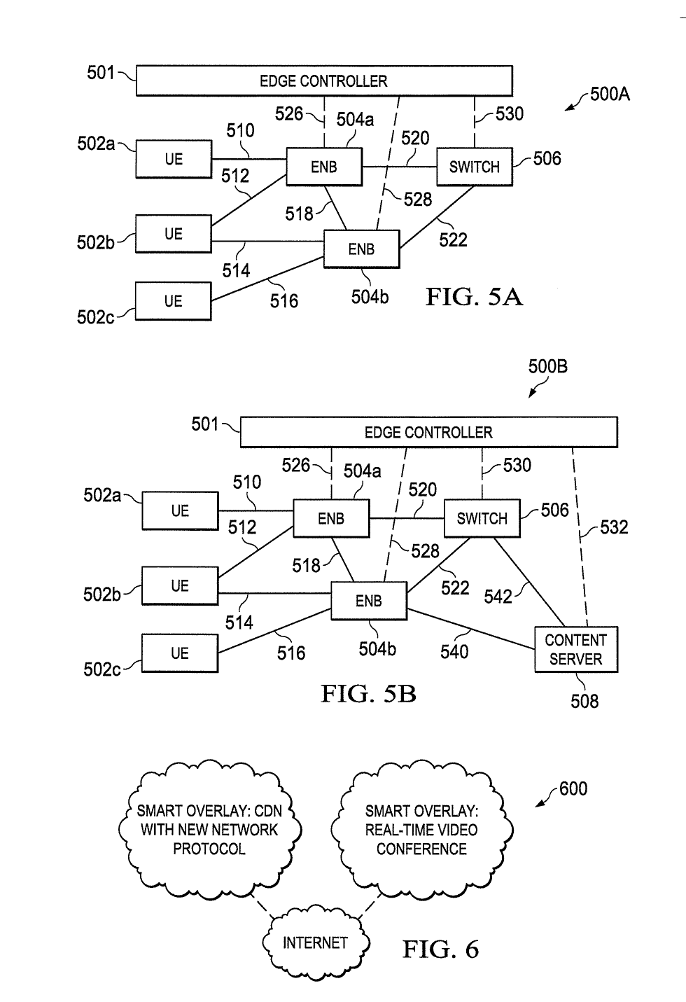

FIG. 5A illustrates a block diagram of a MobiSDN 500A according to an embodiment of this disclosure. MobiSDN 500A may be an example of MobiSDN 400 as shown in FIG. 4A. The embodiment of the MobiSDN 500 shown in FIG. 5A is for illustration only. Other embodiments of the system could be used without departing from the scope of the present disclosure. In an embodiment, MobiSDN 500 includes edge controller 501, UEs 502, eNBs 504, and switch 506.

In an example embodiment, edge controller 501 can communicate with eNBs 504 and switch 506 in the control plane. Additionally, UEs 502, eNBs 504, and switch 506 can communicate in the data plane. In one example, when UE 502a is attempting to communicate with UE 502b, the edge controller 501 may set a route for data forwarding from through connection 510 to 512. In another example, the route may be set as connection 510 to 518 to 514. In yet another example, the route may be set as connection 510 to 520 to 522 to 514. In another example, when UE 502a is attempting to communicate with UE 502c, the edge controller 501 may set a route for data forwarding from through connection 510 to 518 to 516. In another example, the route may be set as connection 510 to 520 to 522. In other examples, other routes may be set by edge controller 501. The routes may be set based on many factors such as, but not limited to, latency, efficiency, load levels, link availability, and the like.

FIG. 5B illustrates a block diagram of a MobiSDN 500B according to an embodiment of this disclosure. MobiSDN 500B may be an example of MobiSDN 400 as shown in FIG. 4A. The embodiment of the MobiSDN 500 shown in FIG. 5B is for illustration only. Other embodiments of the system could be used without departing from the scope of the present disclosure. In an embodiment, MobiSDN 500B includes edge controller 501, UEs 502, eNBs 504 with MobiSDN capability, switch 506, and content server 508.

In an example embodiment, edge controller 501 can communicate with eNBs 504, switch 506 and content server 508 in the control plane. Additionally, UEs 502, eNBs 504, switch 506, and content server 508 can communicate in the data plane. Each eNB has a cellsite server. In one example, when UE 502a is attempting to request content, and request first arrives at eNB 504a. If eNB 504a cellsite server or the SDN switch can perform DPI. If eNB 504a cellsite server has the content, the content can be provided to the UE from eNB504a. If eNB 504a cellsite server does not have the content, the request can be forwarded to SDN controller (edge controller 501). The edge controller can consult with a DFS (for example, DFS manager located in content server 508) using the control plane. Or alternatively, eNB504a can forward the request to the content server 508 via switch 506. The DFS knows which content or which portion of the content is at which location. If the requested content is located in the content server 508, the content server can provide the content to the UE 502a. The content server will let SDN controller know that it has the content, and the SDN controller can figure out a best route from the content server to the UE (for example, via 542, 520, and 510), and the SDN controller can request the data forwarding from the content server to the eNB 504a cellsite server, and eNB 504a provided content to the UE. If the requested content is not located in the content server 508, but located in the eNB 504b cellsite server, the content server will let SDN controller know that eNB 504b has the content, and the SDN controller can figure out a best route from eNB 504b to the UE (for example, via 518, and 510, with lowest latency), and the SDN controller can request the data forwarding from the eNB 504b cellsite server to the eNB 504a cellsite server, and eNB 504a provided content to the UE. The routes may be set based on many factors such as, but not limited to, latency, efficiency, load levels, link availability, and the like. If both content server 508 and eNB 504b cellsite server have the content, the SDN controller can select a source server and a best route to deliver the content. For example, if the route from eNB 504b to UE 502a has lower latency than the route from the content server 508 to UE 502a, the SDN can choose eNB 504b as the source to provide content, and choose a route (e.g., via 518 and 510) with lowest latency to provide the content to the UE. If no content is in the edge, the edge controller may consult the central controller, or the request can go to the internet remote server.

FIG. 6 illustrates a diagram of smart overlay networks 600 for CDN and real-time application according to an embodiment of this disclosure. In one embodiment, super content distribution network (CDN) as an exemplary use case for mobile software defined networks/networking (MobiSDN) is considered. The embodiment of the smart overlay networks 600 shown in FIG. 6 is for illustration only. Other embodiments of smart overlay networks could be used without departing from the scope of the present disclosure.

Super smart-overlay networks can be on top of the Internet, to enjoy novel network architecture, network protocols, and the like. Many new designs can be brought up, in a clean slate manner. Different smart-overlay networks can co-exist, with different protocol sets. For example, a smart overlay network can be for super CDN with new network protocol, and another smart overlay network can be for real-time video conferences. FIG. 2 shows an example.

In super CDN, video quality can be adapted when congestion happens in mobile network, for example, an edge server lowers video quality to reduce bandwidth requirement, or allocate more radio resource for videos requiring high frame rate (such as action movie); less radio resources for videos requiring low frame rate (such as anchor reading news). Video adaptation can be also be done by dropping frames, switching among streams with different resolution, transcoding videos, etc.

Video cache can be shared among edge servers. It can use SDN to direct videos from a remote eNB to the eNB associated with the UE. It can cache video on the edge server and share cache among different edge servers.

Clean-slate overlay can be used. For example, information centric, or content centric, or name defined networks can be used, which are data/content oriented, rather than point-to-point oriented. Content can be identified by its names. Content requestor can get content pieces from multiple nodes such as caching nodes. Protocol will enable efficient content distribution with lower cost and latency.

UE gets content from remote content server for the state-of-the-art CDN. Local server sits aside to eNodeB. Local server stores popular content and provides content.

If no hit, the local server can call another server (e.g., in P-GW). If still no hit, it calls for remote server. Local server first tries to provide requested content locally. If no content found, it calls another server (e.g., in P-GW). If still no hit, it calls remote server.

If a local eNodeB does not have content the UE desires, via SDN, the controller can choose a remote eNodeB to provide content.

Some small cells are connected to small cell gateway which is connected to the S-Gateway via Ethernet, hence SDN can be easily applicable, even with the existing EPC. More small cells (e.g., HeNB) will be deployed, such as indoor. Small cell gateway can be used, which can be connected to the core via the Ethernet. SDN can be easily applied to the edge.

Via SDN, the controller can choose multiple nodes (cells, or WiFi nodes, etc.) to provide content to a UE, with different content or content segments from different nodes.

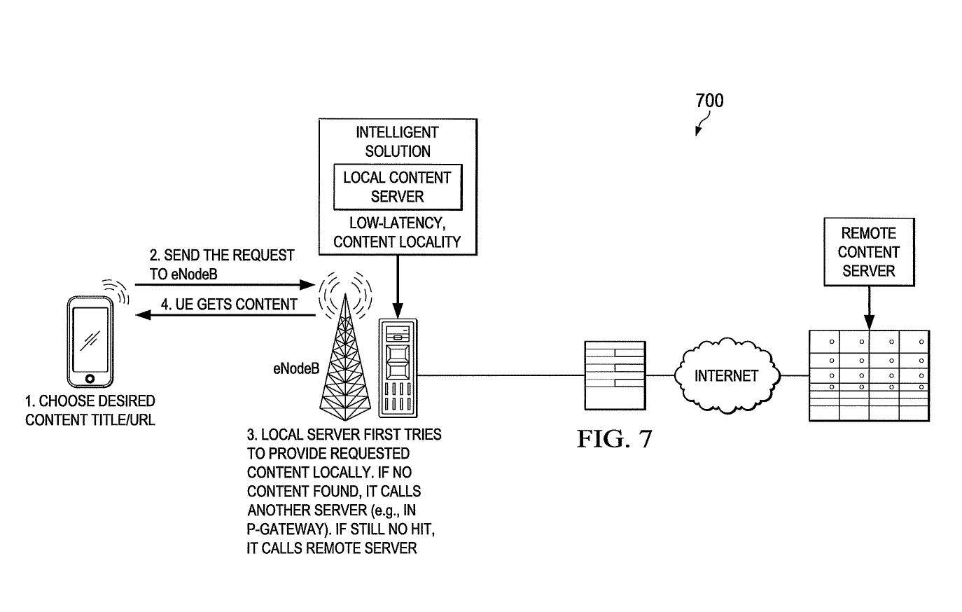

FIG. 7 illustrates a system 700 using an edge server to reduce the content provision latency according to an embodiment of this disclosure. System 700 may use a MobiSDN such as MobiSDN 400 as shown in FIG. 4. The embodiment of the system 700 shown in FIG. 7 is for illustration only. Other embodiments of the system could be used without departing from the scope of the present disclosure.

In an embodiment of this disclosure, the UE first chooses desired content tile or URL. The UE then sends the request to eNB. eNB has a local server. The local server first tries to provide requested content locally. If no content found, it calls another server, such as in P-GW. If still no hit, it calls remove server. It may or may not need SDN for this.

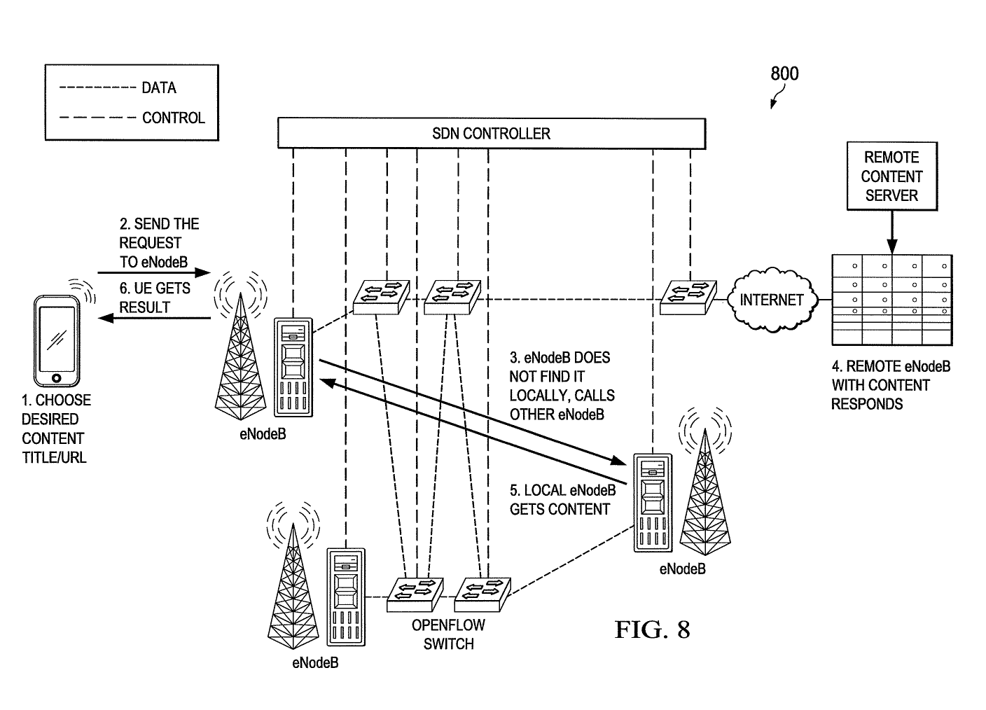

FIG. 8 illustrates a system 800 using MobiSDN for CDN, where edge node (eNB, or WiFi, etc.) can coordinate content according to an embodiment of this disclosure. System 800 may use a MobiSDN such as MobiSDN 400 as shown in FIG. 4. The embodiment of the system 800 shown in FIG. 8 is for illustration only. Other embodiments of the system could be used without departing from the scope of the present disclosure.

In an embodiment of this disclosure, a UE chooses desired content title or URL, and sends the request to eNB. If the eNB finds the content in its edge server locally, it returns the content, otherwise, it calls other eNB or eNBs. A remote eNB with the requested content responds, and forward the content to the eNB who requests. Local eNB gets content and then provides the content to the UE. SDN controller can help forward the content.

Note that alternatively, the local eNB calls other eNBs for content, the SDN controller can help find which eNB can have the content, and direct the local eNB's call to the right eNB who has the content, or ask the eNB who has the content to forward the content and help the forwarding. For such, the SDN controller should have a content mapping, e.g., which eNB has which contents.

Throughout the disclosure, Openflow switch is used as an example of the SDN switch. Openflow switch can be interchangeable to SDN switch. It is noted that SDN switch may apply other protocol than Openflow.

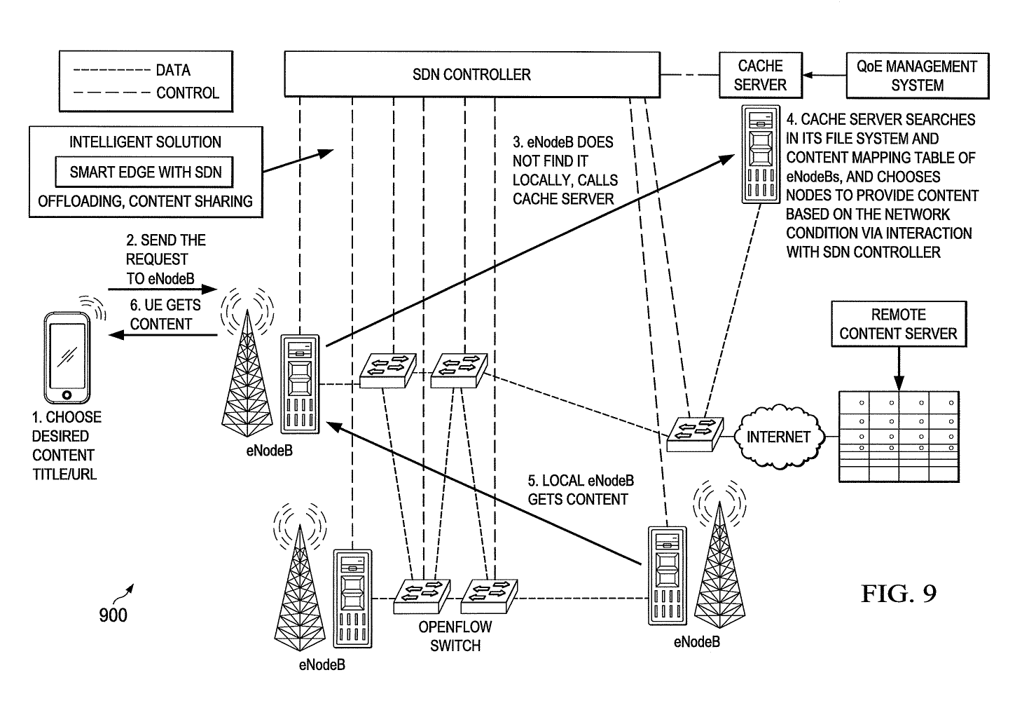

FIG. 9 illustrates a system 900 using MobiSDN for CDN, where a cache server can coordinate content according to an embodiment of this disclosure. System 900 may use a MobiSDN such as MobiSDN 400 as shown in FIG. 4. The embodiment of the system 900 shown in FIG. 9 is for illustration only. Other embodiments of the system could be used without departing from the scope of the present disclosure.

In an embodiment of this disclosure, a UE chooses desired content title or URL, and sends the request to eNB. If the eNB finds the content in its edge server locally, it returns the content, otherwise, it calls cache server. The cache server searches in its file system and content mapping table of eNBs, and chooses nodes to provide content based on the network condition via interaction with SDN controller. Then the SDN helps forward the content from the eNB who has the content to the local eNB. The local eNB gets content and provides to the UE. The communication between cache server and eNBs (cellsite nodes) exists but it is not shown in the figure for brevity.

A QoE (quality of experience) management system (which will be described further later in the embodiment) can help the cache server determine what to cache and where to cache. The content may have a naming system, so that the file system can search or query based on the names.

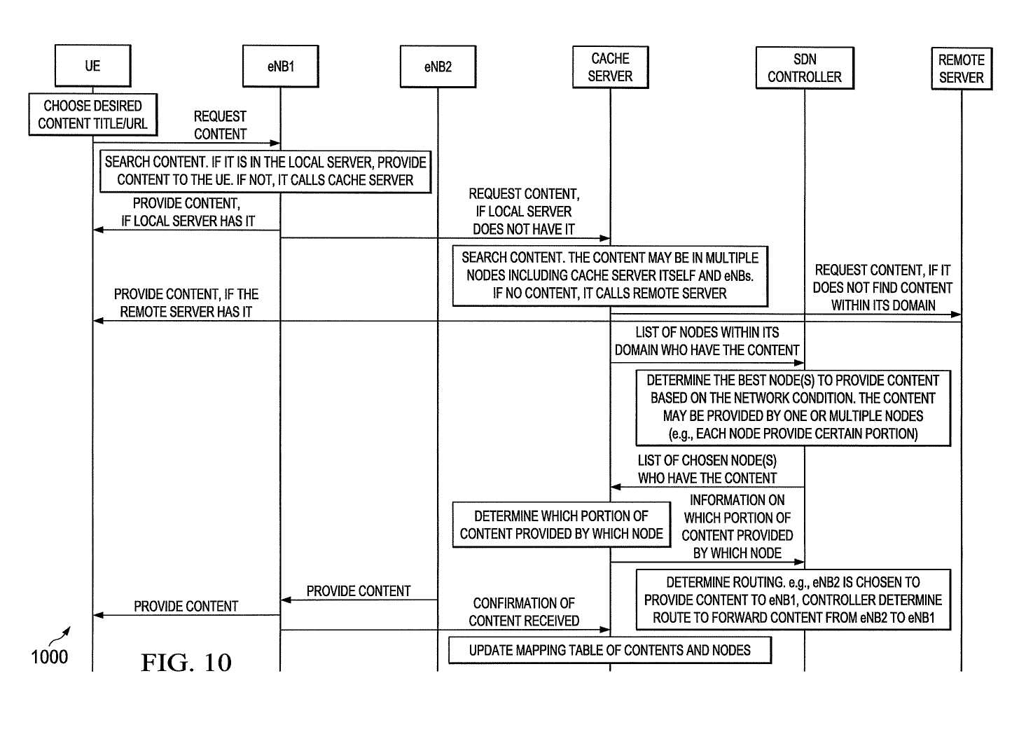

FIG. 10 illustrates a sequence flow 1000 using MobiSDN for CDN, where a cache server can coordinate content according to an embodiment of this disclosure. Sequence flow 1000 may use a MobiSDN such as MobiSDN 400 as shown in FIG. 4 or system 900 as shown in FIG. 9. The embodiment of the sequence flow 1000 shown in FIG. 10 is for illustration only. Other embodiments of the sequence flow could be used without departing from the scope of the present disclosure.

In an embodiment of this disclosure, a UE chooses desired content title or URL. The UE sends request to eNB1. ENB1 searches content in its local edge server. If the requested content is in the local server, it provides the content to the UE. If not, it calls cache server. The cache server searches the content. The content may be in multiple nodes including cache server itself and eNBs. If no content, it calls remote server. If the cache server finds the content within its domain, it finds a list of nodes that have the content, and provide the list to SDN controller. Cache server may also provide the node who requests the content to the SDN controller (in this case, eNB1). The controller determines the best node or nodes to provide content based on the network condition (for example, the best node can be the one which has the least latency to eNB1). The content may be provided by one or multiple nodes (e.g., each node provide certain portion). The SDN provides the list of chosen node(s) who have the content to the cache server, and the cache server determines which portion of content provided by which node, and provide the information to the SDN controller (this step may be omitted if there is only one node providing the content). The SDN controller then determines routing (e.g., eNB2 is chosen to provide content to eNB1, controller determines to forward content from eNB2 to eNB1). Then eNB2 provides content to eNB1, and eNB1 provides content to the UE. eNB1 can send confirmation of content received to the cache server. The cache server then updates mapping table of contents and nodes.

Note that cache server and SDN controller can be merged to as one controller, then the communication in-between these two can be omitted.

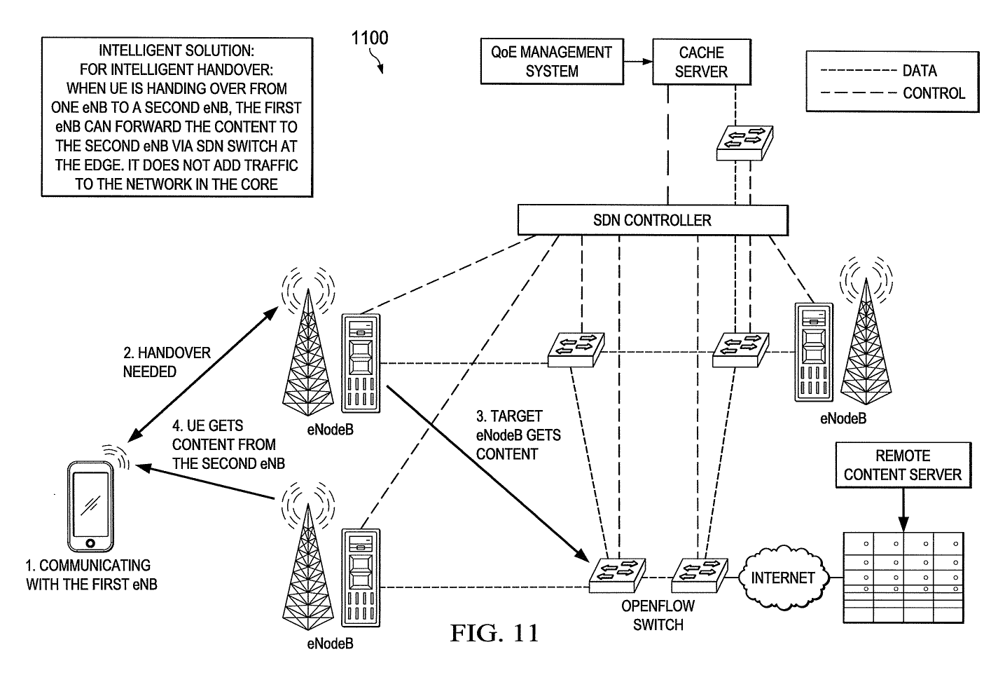

FIG. 11 illustrates a system 1100 using MobiSDN for CDN when a UE hands over according to an embodiment of this disclosure. System 1100 may use a MobiSDN such as MobiSDN 400 as shown in FIG. 4. The embodiment of the system 1100 shown in FIG. 11 is for illustration only. Other embodiments of the system could be used without departing from the scope of the present disclosure.

In an embodiment of this disclosure, when a UE is handing over from one eNB to a second eNB, the first eNB can forward the content to the second eNB via SDN switch at the edge. It keeps the traffic in the edge. It does not add traffic to the network in the core.

In an example embodiment, a UE communicates with a first eNB. When handover is needed, the serving eNB (the first eNB) forward the content to the target eNB (a second eNB) via SDN, and then the UE gets content from the second eNB.

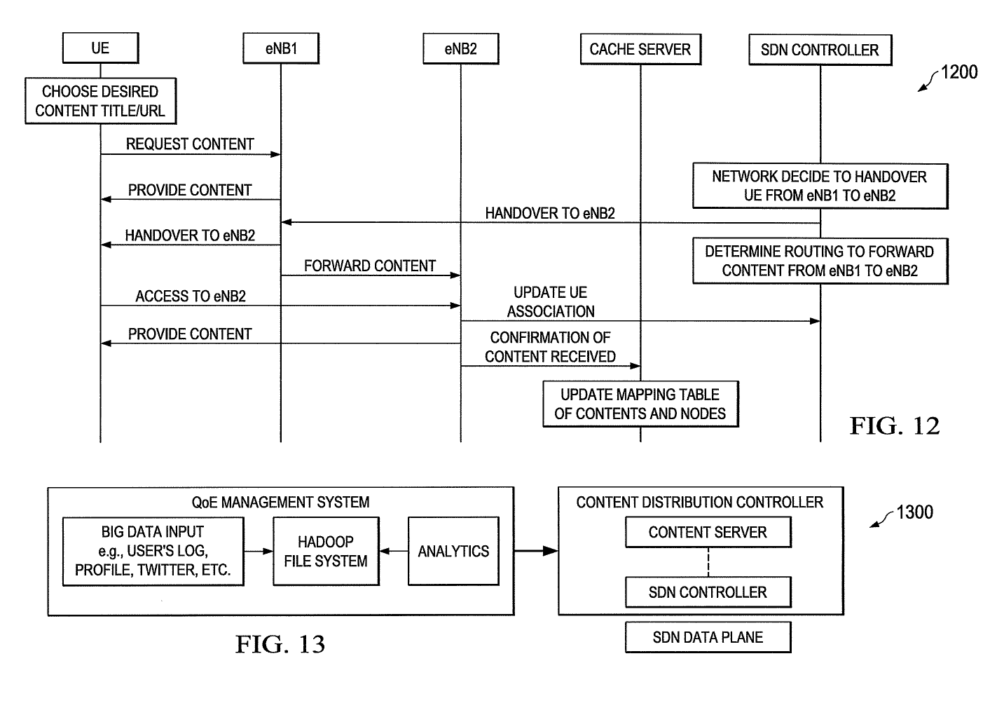

FIG. 12 illustrates a sequence flow 1200 using SDN for CDN when UE hands over according to an embodiment of this disclosure. Sequence flow 1200 may use a MobiSDN such as MobiSDN 400 as shown in FIG. 4 or system 1100 as shown in FIG. 11. The embodiment of the sequence flow 1200 shown in FIG. 12 is for illustration only. Other embodiments of the sequence flow could be used without departing from the scope of the present disclosure.

In an embodiment of this disclosure, UE communicates eNB1 with some content. Network decides to handover UE from eNB1 to eNB2. The SDN controller determines routing to forward, content from eNB1 to eNB2. eNB1 forwards content to eNB2. The cache server updates mapping table of contents and nodes.

Note that the SDN controller and cache server may be merged as one controller, referred as content distribution controller. If SDN controller and cache server are merged, the communication in-between these two may be omitted as it becomes internal implementation.

FIG. 13 illustrates a QoE management system 1300 and content distribution controller according to an embodiment of this disclosure. QoE management system 1300 helps manage end users quality of experience. It uses big data (e.g., user's log, profile, twitter, etc.) analytics (e.g., using Hadoop file system) to decide caching which content, cache update, recommendation, distribution, and the like. The embodiment of the system 1300 shown in FIG. 13 is for illustration only. Other embodiments of the system could be used without departing from the scope of the present disclosure.

In one or more embodiments, a cache server can use file system. It may use content name based networking. It can cache content from remote content server via Internet, distribute content towards the edge nodes, and find which nodes would have the requested content by the UE, and inform the information of the nodes to SDN controller. After receiving the information that the SDN controller selects, it can order the node to forward content to another node.

The SDN controller can decide which node to deliver the content if there are multiple nodes based on the network condition, let cache server know the decision and trigger cache server to order the node to forward content to another node, and route the content from the selected node to the destination.

In an embodiment of this disclosure, a Hadoop file system has big data input such as user's log, profile, twitter, etc., and big data analytics to analyze the data. The QoE management system can output the content caching recommendation, content distribution recommendation, etc., and feed its output to content distribution controller. The content distribution controller has cache server and SDN controller. SDN controller and SDN data plane forms the MobiSDN network, where the hardware includes radio nodes (eNB, WiFi, etc.), edge servers, switches, and the software includes the central controller which has the intelligence.

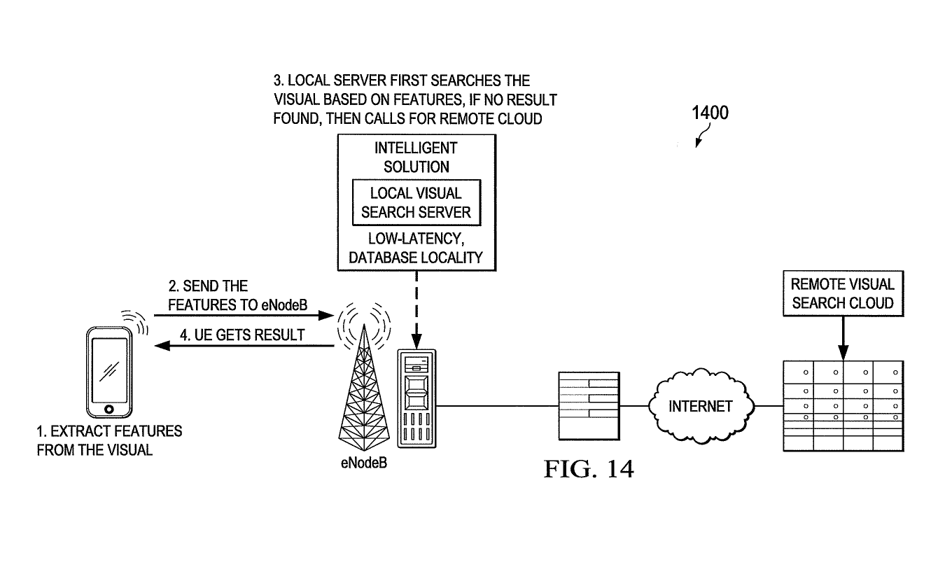

FIG. 14 illustrates a system 1400 using MobiSDN for using an edge server to reduce the visual search latency according to an embodiment of this disclosure. System 1400 may use a MobiSDN such as MobiSDN 400 as shown in FIG. 4. The embodiment of the system 1400 shown in FIG. 14 is for illustration only. Other embodiments of the system could be used without departing from the scope of the present disclosure.

In one embodiment, super search as an exemplary use case for MobiSDN is considered. Cloud service can be provided on the mobile edge, where one or multiple edge nodes (e.g., eNB, WiFi) can jointly serve the UE's request on the search. It can have low latency. Localized search queries, localized indexing/ranking can be applied. The database can be shared by multiple edge servers. As a single server may have limited storage, information can be shared by neighboring edge servers. The search and processing for a UE's query can be firstly done in a local edge server. If the local server does not have the results, interim search or processing result can be forwarded to other nodes including neighboring edge servers and visual search server to get further search for the results. An example is for visual search, where visual indexing/ranking and system support of visual database sharing among edge servers can be used.

In an embodiment of this disclosure, the UE first extract features from the visual (for example, the UE extract feature from the camera pictures, video, etc.). The UE then sends the features to eNB. eNB has a local server. The local server first searches the visual based on the features. If no results found, it calls another search node, such as in P-GW. If still no hit, it calls remote visual search cloud. UE's features, and/or the interim search or processing results can also be forwarded from one search node to the next search node. It may or may not need SDN for this. SDN can be used to further optimize the routing of the UE's features to the search nodes, interim results/processing from a search node to the next search node, and the search results from the search nodes to the UE.

One or more embodiments of this disclosure recognize and take into account that traditionally the search is done in a remote cloud. The feature sent from the UE and the result from the remote cloud should travel long path. Local server sits aside to eNB. Local server searches for the results and return the results to the UE and it can reduce the latency.

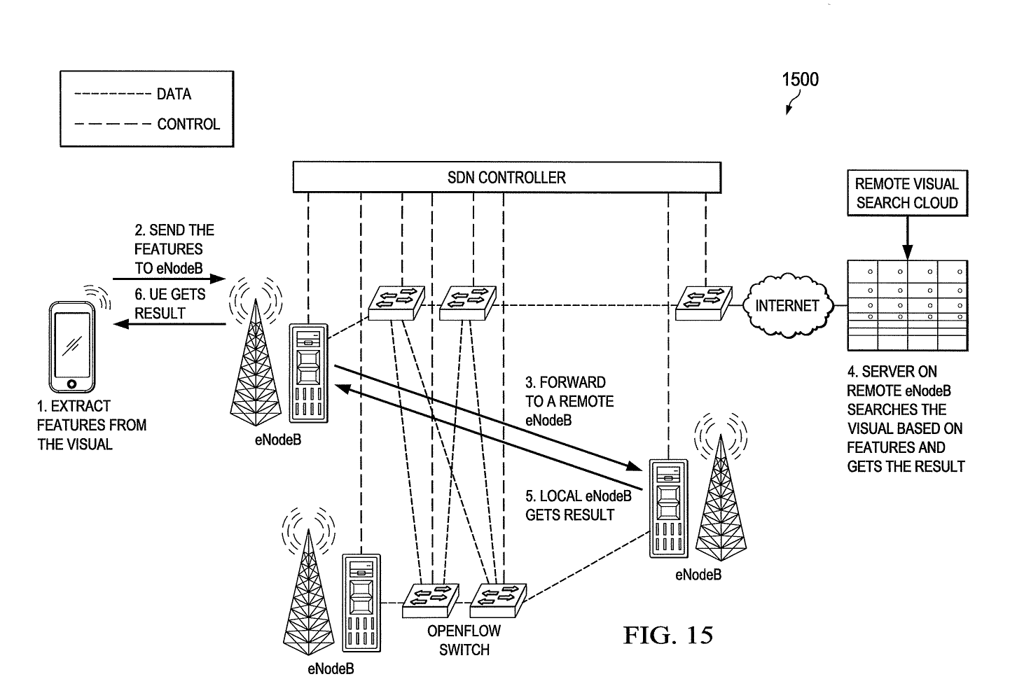

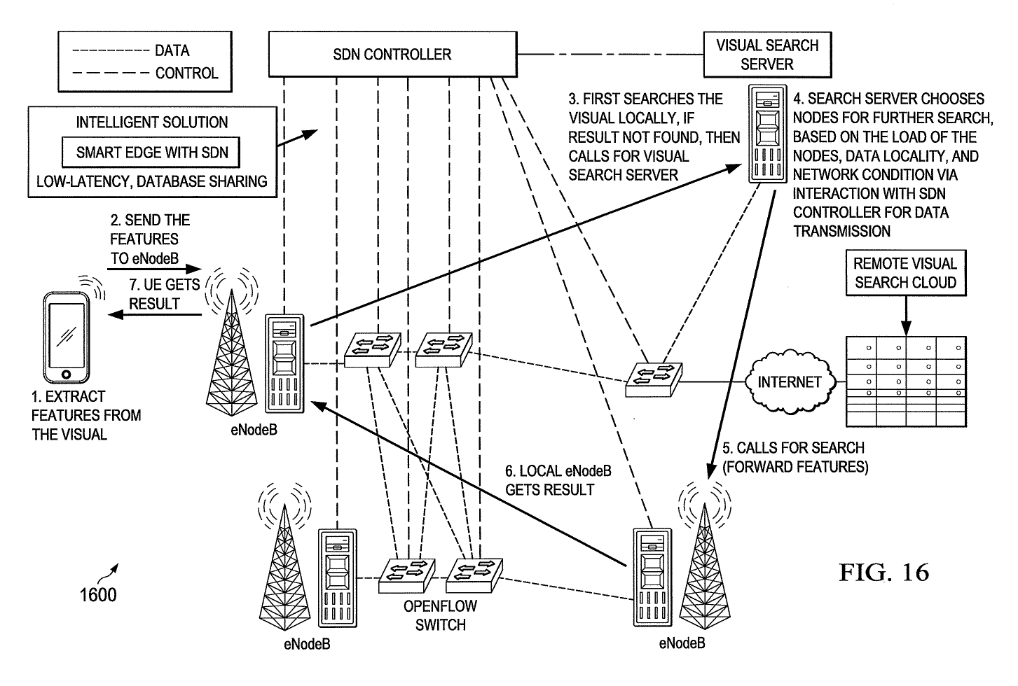

FIG. 15 illustrates a system 1500 using MobiSDN for visual search, where edge node (eNB, or WiFi, etc.) can coordinate a search according to an embodiment of this disclosure. System 1500 may use a MobiSDN such as MobiSDN 400 as shown in FIG. 4. The embodiment of the system 1500 shown in FIG. 15 is for illustration only. Other embodiments of the system could be used without departing from the scope of the present disclosure.

In an embodiment of this disclosure, the UE first extract features from the visual (for example, the UE extract feature from the camera pictures, video, etc.). The UE then sends the features to eNB. eNB has a local server. The local server first searches the visual based on the features. If no results found, it calls other search nodes, such as other eNBs. If still no hit, it calls remote visual search cloud. UE's features, and/or the interim search or processing results can also be forwarded from one search node to the next search node. SDN can be used to further optimize the routing of the UE's features to the search nodes, interim results/processing from a search node to the next search node, and the search results from the search nodes to the UE.

Alternatively, the local eNB calls other eNBs for search results, the SDN controller can help find which eNB can have the processing power, and possibly have the search results (for example, a similar query has been conducted and certain results are in the eNB), and direct the local eNB's call to the right eNB who has the results, or ask the eNB who has the results to forward the content and help the forwarding. For such, the SDN controller should have a search results and UE's features mapping w.r.t. search nodes (e.g., eNBs), e.g., which eNB has which search results and for what kind of visual features. The SDN controller may also know the processing load of each search node (e.g., eNB), then it can further take into account the processing load when it chooses or finds which eNB can perform further search for the local eNB who calls for help.

FIG. 16 illustrates a system 1600 using MobiSDN for visual search, where a visual search server can coordinate a search according to an embodiment of this disclosure. Sequence flow 1600 may use a MobiSDN such as MobiSDN 400 as shown in FIG. 4. The embodiment of the system 1600 shown in FIG. 16 is for illustration only. Other embodiments of the system could be used without departing from the scope of the present disclosure.

In an embodiment of this disclosure, the UE first extract features from the visual (for example, the UE extract feature from the camera pictures, video, etc.). The UE then sends the features to eNB. eNB has a local server. The local server first searches the visual based on the features. If no results found, it calls other search nodes, such as the visual search server. The visual search server chooses nodes to provide further search, based on the processing load of the nodes, data locality (e.g., whether the data is locally in the node), and network condition via interaction with SDN controller. UE's features, and/or the interim search or processing results can also be forwarded from one search node to the next search node. SDN can be used to further optimize the routing of the UE's features to the search nodes, interim results/processing from a search node to the next search node, and the search results from the search nodes to the UE. After the local search node (eNB) gets the result, it returns the result to the UE.

The visual search server may have a mapping table about search results and UE's features with respect to search nodes (e.g., eNBs). For example, which eNB has which search results and for what kind of visual features. Visual search server may also have the processing load information of the edge search nodes (e.g., eNBs). The communication between visual search server and eNBs (cellsite nodes) exists but it is not shown in the figure for brevity.

The visual search server and the SDN controller may be merged to a single controller, then the interaction of the visual search server and the SDN controller (e.g., the visual search server tells the SDN controller about the search nodes that it chooses for further search based on the processing load of the nodes, and data locality of the nodes, and the SDN controller tells the visual search server which node(s) among all the nodes that the visual search server chooses are better based on the network condition such as routing, congestion, etc.) can be omitted and become internal implementation.

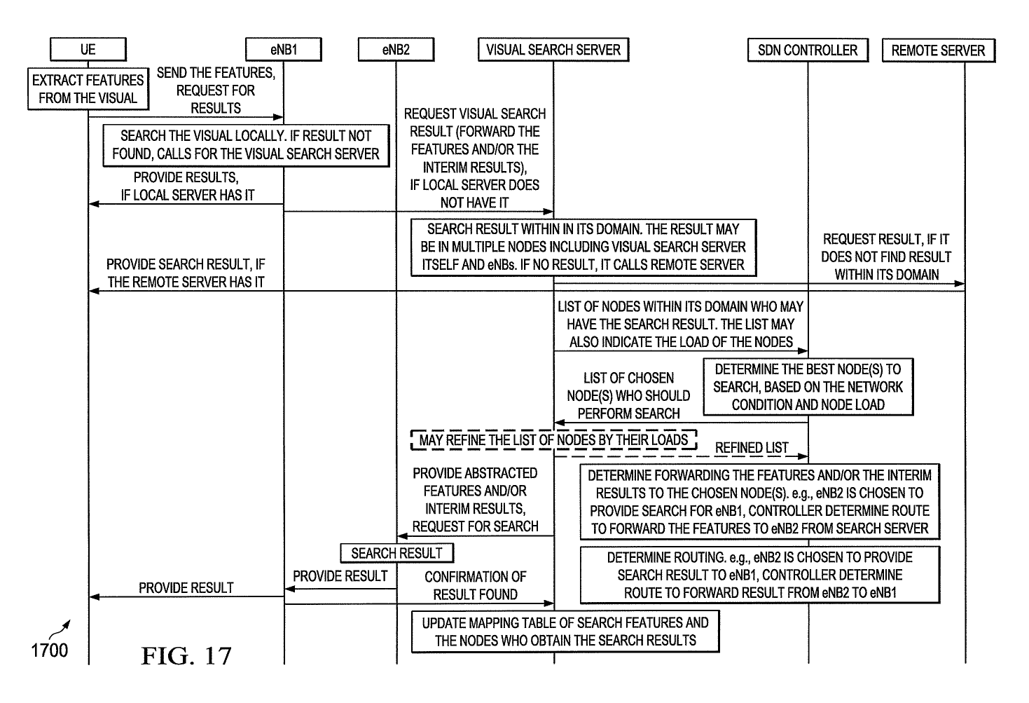

FIG. 17 illustrates a sequence flow 1700 using MobiSDN for visual search, where a visual search server can coordinate a search according to an embodiment of this disclosure. Sequence flow 1700 may use a MobiSDN such as MobiSDN 400 as shown in FIG. 4 or system 1600 as shown in FIG. 16. The embodiment of the sequence flow 1700 shown in FIG. 17 is for illustration only. Other embodiments of the sequence flow could be used without departing from the scope of the present disclosure.

In an embodiment of this disclosure, a UE extracts features from the visual. It sends the features and request for the results to eNB1/eNB1 searches the visual locally. If no result is found, it calls for the visual search server, otherwise, it provides results. eNB1 requests visual search results to the visual search server, and it can forward the extracted features and/or the interim results. The visual search server then search for the result within its domain. The result may be searched by multiple nodes including the visual search server who may have the search results. If no result in the visual search server domain, it calls remote server.

When the visual search server searches within its domain, it can provide a list of nodes within its domain of who may have the search result. The list may include the indication of the load of the nodes (e.g., the computing load, processing load, search load, etc.). Note that the search server can maintain a table of mapping of which nodes may have the search result for the feature or a similar feature, or may have searched for the feature successfully, etc., and the search server may also know the load of the nodes. The SDN controller can determine the best node(s) to search for the result, based on the network condition and node load. Load balancing can be considered as a metric to determine the best node(s). The SDN controller then provides a list of chosen node(s) that would perform search. Alternatively (dashed lines), if the visual search server does not provides the load of the nodes, then the SDN controller can determine the best node(s) based on the network conditions, e.g., the best node who would have the shortest path or a path with least latency to eNB1. The visual search server can then refine the list of nodes based the load and it can send the refined list to the SDN controller. The SDN controller then determines forwarding the features and/or the interim results to the chosen node(s). For example, if eNB2 is chosen to provide search for eNB1, controller can determine the route to forward the features to eNB2 from the visual search server (or from eNB1). Then eNB2 will get the request for the search, with the received abstract features and/or the interim search results, and it performs the search. Once eNB2 obtains results, it provides the search result to eNB1. ENB1 or eNB2 can also confirm to the visual search server that the result is found, so that the visual search server can update the mapping table of search features and the nodes that obtain the search results. If eNB2 fails to get result, it will report to the visual search server, so that another node may be chosen, or the remote search may be called.

In an example embodiment, the visual search server and SDN controller can be merged to as one controller, then the communication in-between these two can be omitted, or implemented within the said one controller.

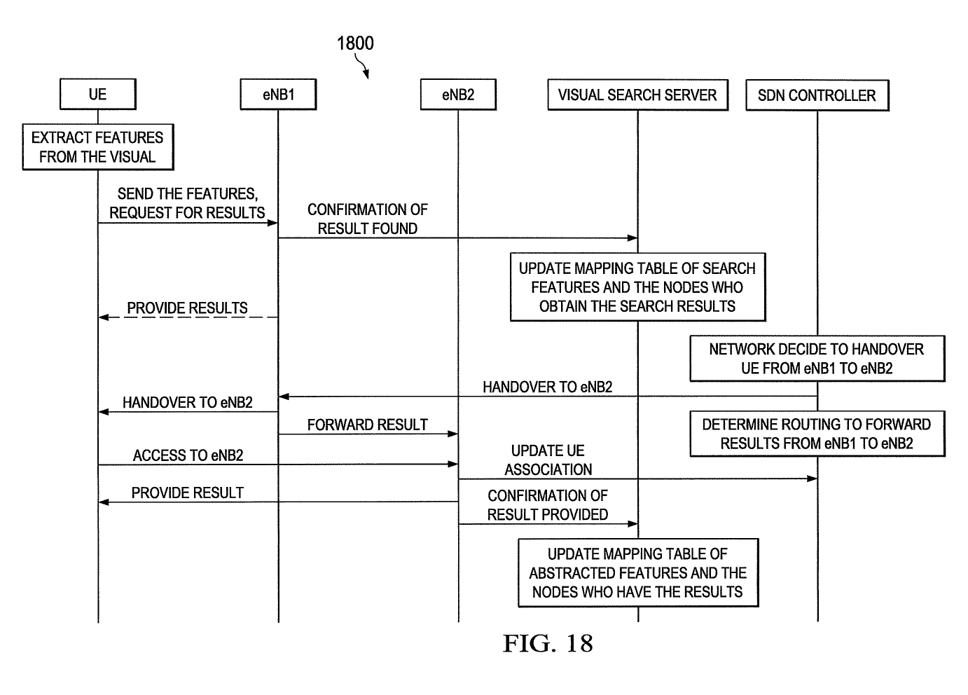

FIG. 18 illustrates a sequence flow 1800 using MobiSDN for visual search when UE hands over according to an embodiment of this disclosure. Sequence flow 1800 may use a MobiSDN such as MobiSDN 400 as shown in FIG. 4. The embodiment of the sequence flow 1800 shown in FIG. 18 is for illustration only. Other embodiments of the sequence flow could be used without departing from the scope of the present disclosure.

In an embodiment of this disclosure, UE communicates eNB1 with visual search request. Network decides to handover UE from eNB1 to eNB2 at some point (e.g., due to the mobility of the UE). If eNB1 has the search result already, the SDN controller determines routing to forward search result from eNB1 to eNB2. Note that for such, eNB1, once it obtains the result, it may contact the visual search server indicating that it has the visual search result for which feature, and the visual search server may let SDN controller know that eNB1 has the result already. Then eNB1 forward the result to eNB2, and eNB2 provides result to the UE once the UE accesses it. eNB2 can confirm with the visual server that it has the result forwarded by eNB1, and the visual search serve updates mapping table of abstracted features and the nodes who have the results.

In another example, if eNB1 has not yet obtained the search result for the UE, eNB1 can send the abstracted feature from the UE and/or the interim result to the visual search server, so that the visual search server can search within its domain as described in FIG. 12a.

In an example embodiment, the visual search server and SDN controller can be merged to as one controller, then the communication in-between these two can be omitted, or implemented within the said one controller.

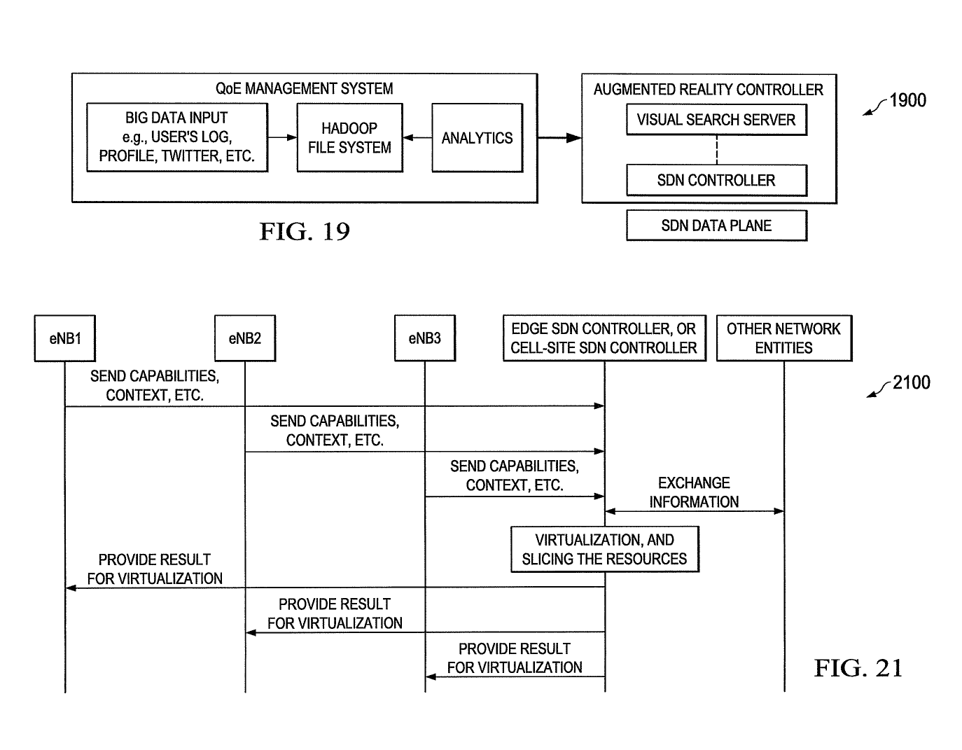

FIG. 19 illustrates a QoE management system 1900 and augmented reality controller according to an embodiment of this disclosure. QoE management system 1900 helps manage end users quality of experience. It uses big data (e.g., user's log, profile, twitter, etc.) analytics (e.g., using Hadoop file system) to decide caching which content, cache update, recommendation, distribution, and the like. The embodiment of the system 1900 shown in FIG. 19 is for illustration only. Other embodiments of the system could be used without departing from the scope of the present disclosure.

In an embodiment of this disclosure, a Hadoop file system has big data input such as user's log, profile, twitter, etc., and big data analytics to analyze the data. The QoE management system can output the visual search recommendation, visual search cache recommendation, visual search data based recommendation, and the like, and feed its output to augmented reality controller. For example, for certain users with certain profiles (e.g., demography based group, such as for skin disease search, etc.), certain features may have some unique characteristics which can be used to narrow down the search scope in the visual search server. The augmented reality controller has visual search server and SDN controller. SDN controller and SDN data plane forms the MobiSDN network, where the hardware includes radio nodes (eNB, WiFi, etc.), edge servers, switches, and the software includes the central controller which has the intelligence.

In an example embodiment, the augmented reality, or visual search, can have diverse use cases, such as for medical usage, disease diagnosis, medication recognition, and the like.

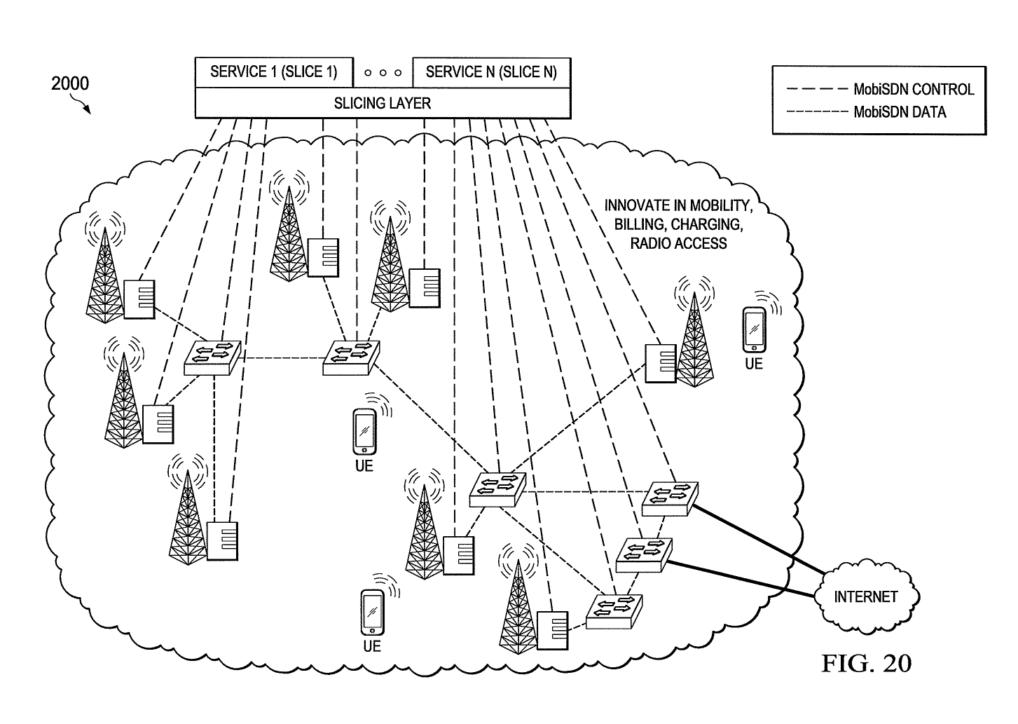

FIG. 20 illustrates a system 2000 using virtualization in MobiSDN according to an embodiment of this disclosure. System 2000 may use a MobiSDN such as MobiSDN 400 as shown in FIG. 4. The embodiment of the system 2000 shown in FIG. 20 is for illustration only. Other embodiments of the system could be used without departing from the scope of the present disclosure.

In one embodiment, virtualization for super soft networking as an exemplary use case for MobiSDN is considered. MobiSDN can provide open interface for applications, and it can get more use cases and value-added or revenue-added services. It can open the network element, it can get more service and business opportunities. Virtualization is a good tool to achieve super soft networking.

Flexible network virtualization can be achieved by slicing flow space, such as using hypervisor. All the hardware can be used as shared infrastructure. Part or the entire infrastructure (e.g., eNBs, switches) can be in a slice. Each slice can be for different value-adding services. It can flexibly provide services and new revenue, with easier management.

In one embodiment, a hypervisor can be used, to support slicing layer, which can support different services. Each slice can be for different service. Each slice can be virtually corresponding to part or the entire hardware at the physical layer.

The virtualization can be extended to smart edge, or cell-site SDN. For example, a cell-site SDN controller, or a smart edge SDN controller can manage the resources. Assume eNB1, eNB2, eNB3 are controlled by a smart edge SDN controller, or a cell-site SDN controller. The SDN controller can virtually slice the layer, for example, resources for eNB1 and eNB2 can be used for service 1, resources for eNB2 and eNB3 can be used for service 2.

FIG. 21 illustrates a sequence flow 2100 using virtualization in MobiSDN with cell-site SDN controller according to an embodiment of this disclosure. Sequence flow 2100 may use a MobiSDN such as MobiSDN 400 as shown in FIG. 4 or system 2000 as shown in FIG. 20. The embodiment of the sequence flow 2100 shown in FIG. 21 is for illustration only. Other embodiments of the sequence flow could be used without departing from the scope of the present disclosure.

In this example embodiment, eNB1, eNB2, eNB3 can send information such as capabilities, context, and so on to the edge SDN controller or cell-site SDN controller. The edge SDN controller or cell-site SDN controller can exchange information with other network entities, such as other edge SDN controller or cell-site SDN controller or central controller, for coordination. The edge SDN controller or cell-site SDN controller can virtualize the resources, or slicing the resources. For example, slicing certain physical resources for each eNB for a certain service, or slicing certain hardware such as eNBs for a certain service. The edge SDN controller or cell-site SDN controller then can provide the result for virtualization for each of these eNBs.

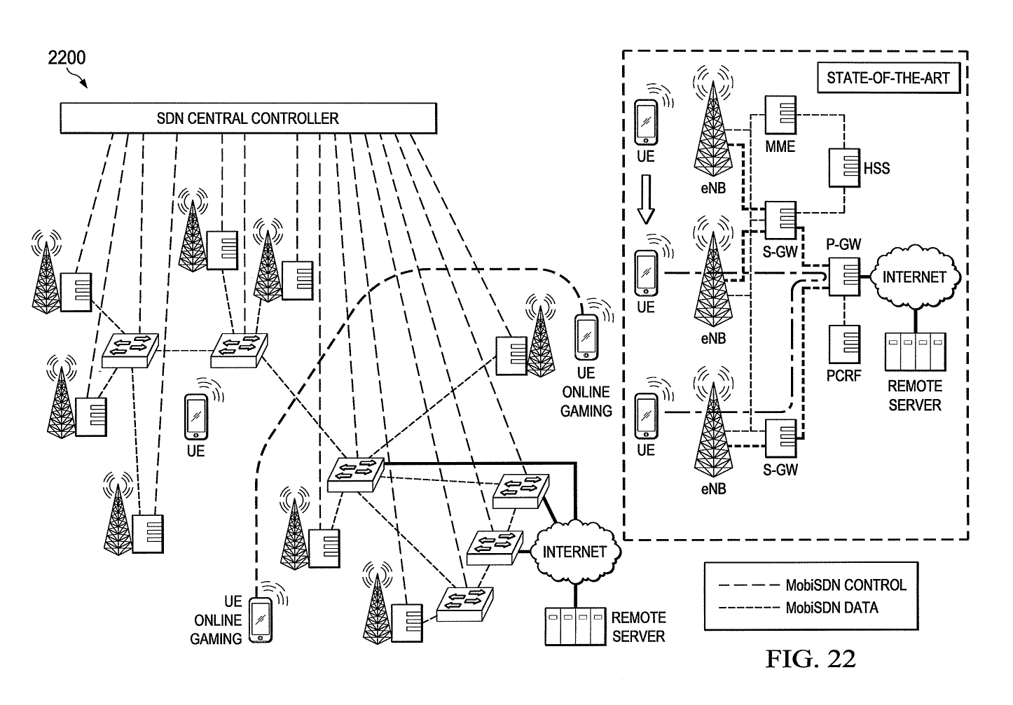

FIG. 22 illustrates a system 2200 using virtualization in MobiSDN for online gaming according to an embodiment of this disclosure. System 2200 may use a MobiSDN such as MobiSDN 400 as shown in FIG. 4. The embodiment of the system 2200 shown in FIG. 22 is for illustration only. Other embodiments of the system could be used without departing from the scope of the present disclosure.

In an embodiment of this disclosure, a user of a UE that wants to have high QoS online gaming can pay more money to use it. The network then can form the slice to prioritize the gaming traffic, as well as finding the route with low latency, to serve the gaming service. More revenue can be achieved. Service for online gaming with high QoS (e.g., revenue adding service) can be virtualized to use a slice with high priority flows. UEs that have online gaming can be connected via nearby eNBs and switches. Unlike the state-of-the-art, it does not need to always go through the P-GW which may be the bottleneck; rather, it can go flexibly to the switches connecting eNBs nearby the UE.

The virtualization can be extended to smart edge, or cell-site SDN. For example, a cell-site SDN controller, or a smart edge SDN controller can manage the resources for a service of online gaming. The UEs which requires online gaming service can request to the eNBs, and eNBs can talk to the cell-site SDN controller, or the smart edge SDN controller. The controller can then decide how to virtualize resources according to the requests, for example, the controller will pick those eNBs which need to serve online gaming service to form a slice, and the UEs can have online gaming on the virtual resources.

The online gaming is used as an example of service. The online gaming can be a category of general online gaming, or it can be for a certain type of online gaming.

The virtualization may be based on the information from eNB in certain time (for example, during the gaming set up procedure) or based on demand from eNB, or it may be based on the statistics or history from which the edge SDN controller or cell-site SDN controller may have learned that the eNB typically would have online gaming service requested by UE.

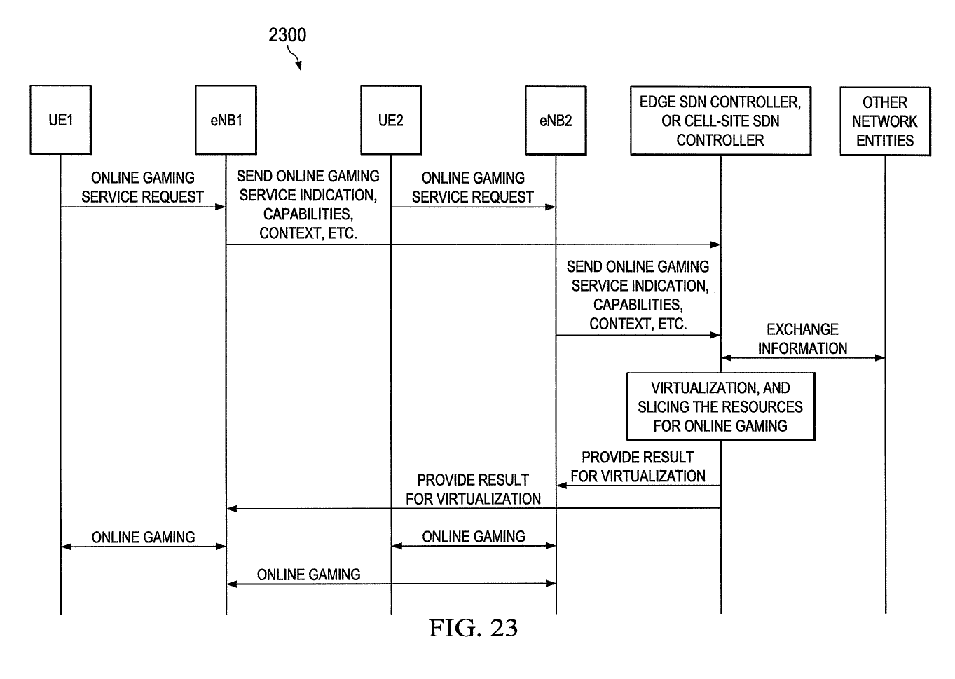

FIG. 23 illustrates a sequence flow 2300 using virtualization in MobiSDN for online gaming with a cell-site SDN controller according to an embodiment of this disclosure. Sequence flow 2300 may use a MobiSDN such as MobiSDN 400 as shown in FIG. 4 or system 2200 as shown in FIG. 22. The embodiment of the sequence flow 2300 shown in FIG. 23 is for illustration only. Other embodiments of the sequence flow could be used without departing from the scope of the present disclosure.

In the example, UE1 and UE2 can send online gaming service request to eNB1, eNB2, respectively. eNB1, eNB2 can send information such as online gaming service indication, capabilities, context, and on to the edge SDN controller or cell-site SDN controller. The edge SDN controller or cell-site SDN controller can exchange information with other network entities, such as other edge SDN controller or cell-site SDN controller or central controller, for coordination. The edge SDN controller or cell-site SDN controller can virtualize the resources, or slicing the resources. For example, slicing certain physical resources for each eNB for a certain service, or slicing certain hardware such as eNBs for a certain service (in this example, eNB1 and eNB2 for online gaming). The edge SDN controller or cell-site SDN controller then can provide the result for virtualization for each of these eNBs. UE1 then can have online gaming service via connection with eNB1, UE2 can have online gaming service via connection with eNB2, and eNB1 and eNB2 can have online gaming service data flow in-between them directly or via switches, and the data flow can come from or go to UE1/UE2. The data flow does not need to go to the core network, for example, via S-GW, P-GW.

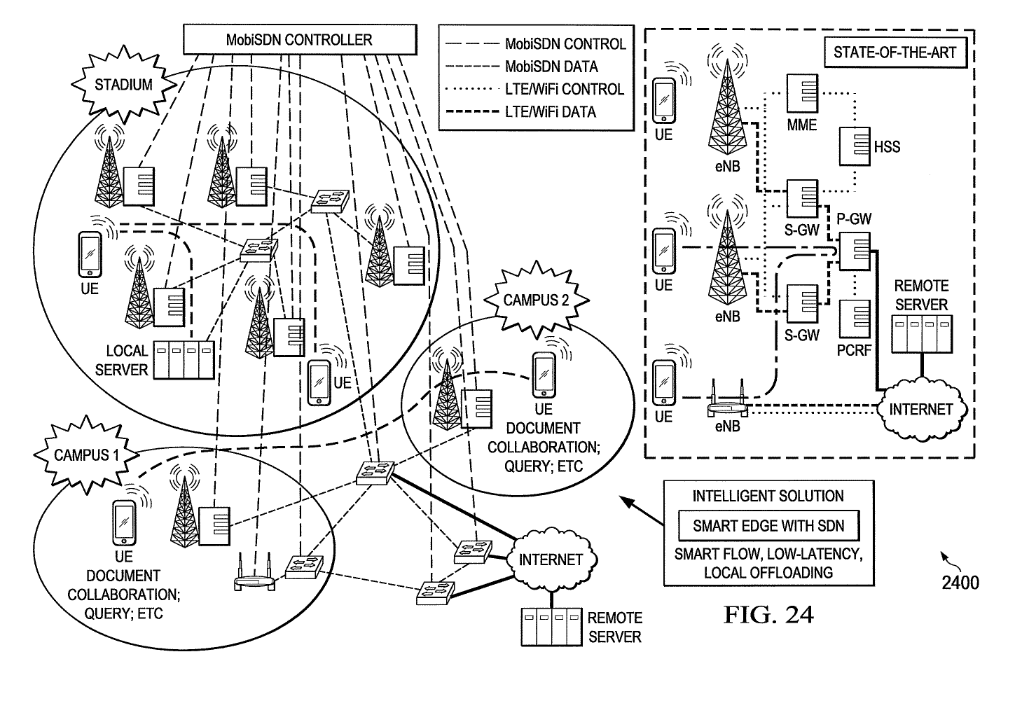

FIG. 24 illustrates a system 2400 using virtualization in MobiSDN for localized service according to an embodiment of this disclosure. System 2400 may use a MobiSDN such as MobiSDN 400 as shown in FIG. 4. The embodiment of the system 2400 shown in FIG. 24 is for illustration only. Other embodiments of the system could be used without departing from the scope of the present disclosure.

In an example embodiment, an enterprise can have multiple campuses. More money can be charged to the enterprise, to provide low latency interactive wireless service, such as allowing employees to have high QoS interactive wireless video conferencing, document collaboration query processing, and the like. A slice can be formed by including the base stations close to the campuses (not all the base stations are needed; simplify networking). This system creates more revenue with easier management.

Local base stations within the stadium can form a slice, to provide local value adding services to the UEs. UE can pay more money to get better service, or participate to certain events such as video contest, etc. Content, such as players introduction, video re-play of exciting pieces of the game, etc., can be in the local server. UE can also upload its captured video or other content to the local server, to share with the others. If UE provides very good video clip and get many hits from others, the UE can get some incentive.

The virtualization for localized service can be extended to smart edge, or cell-site SDN. For example, a cell-site SDN controller, or a smart edge SDN controller can manage the resources for a service in stadium. A cell-site SDN controller or a smart edge SDN controller can manage the resources for a service in campuses.

In different example embodiments, the virtualization may be based on the location of the eNBs, such as the eNBs in stadium, or around the campuses.

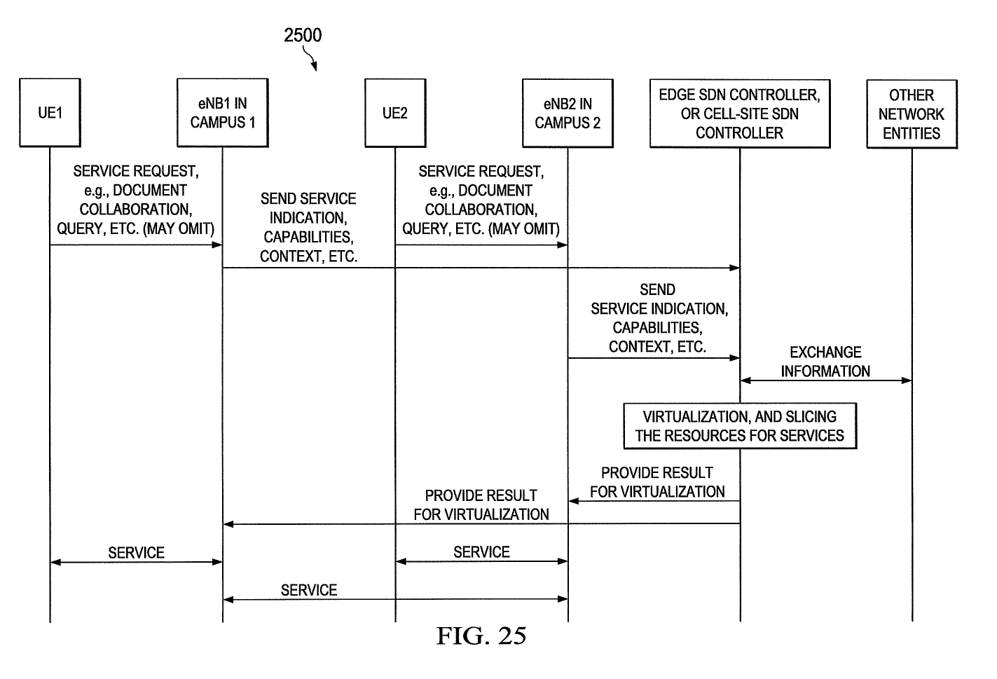

FIG. 25 illustrates a sequence flow 2500 using virtualization in MobiSDN for localized service with a cell-site SDN controller according to an embodiment of this disclosure. Sequence flow 2500 may use a MobiSDN such as MobiSDN 400 as shown in FIG. 4 or system 2400 as shown in FIG. 24. The embodiment of the sequence flow 2500 shown in FIG. 25 is for illustration only. Other embodiments of the sequence flow could be used without departing from the scope of the present disclosure.

In the example, UE1 and UE2 may send service request (for example, document collaboration, query, etc.) to eNB1 in campus 1, eNB2 in campus 2, respectively. eNB1, eNB2 can send information such as service indication, capabilities, context, and so on to the edge SDN controller or cell-site SDN controller. The edge SDN controller or cell-site SDN controller can exchange information with other network entities, such as other edge SDN controller or cell-site SDN controller or central controller, for coordination. The edge SDN controller or cell-site SDN controller can virtualize the resources, or slicing the resources. For example, slicing certain physical resources for each eNB for a certain service, or slicing certain hardware such as eNBs for a certain service (in this example, eNB1 and eNB2). The edge SDN controller or cell-site SDN controller then can provide the result for virtualization for each of these eNBs. UE1 then can have service via connection with eNB1, UE2 can have service via connection with eNB2, and eNB1 and eNB2 can have service data flow in-between them directly or via switches, and the data flow can come from or go to UE1/UE2. The data flow does not need to go to the core network, for example, via S-GW, P-GW.

For the stadium case, the UE may have services to another UE or to local server via eNBs or switches.

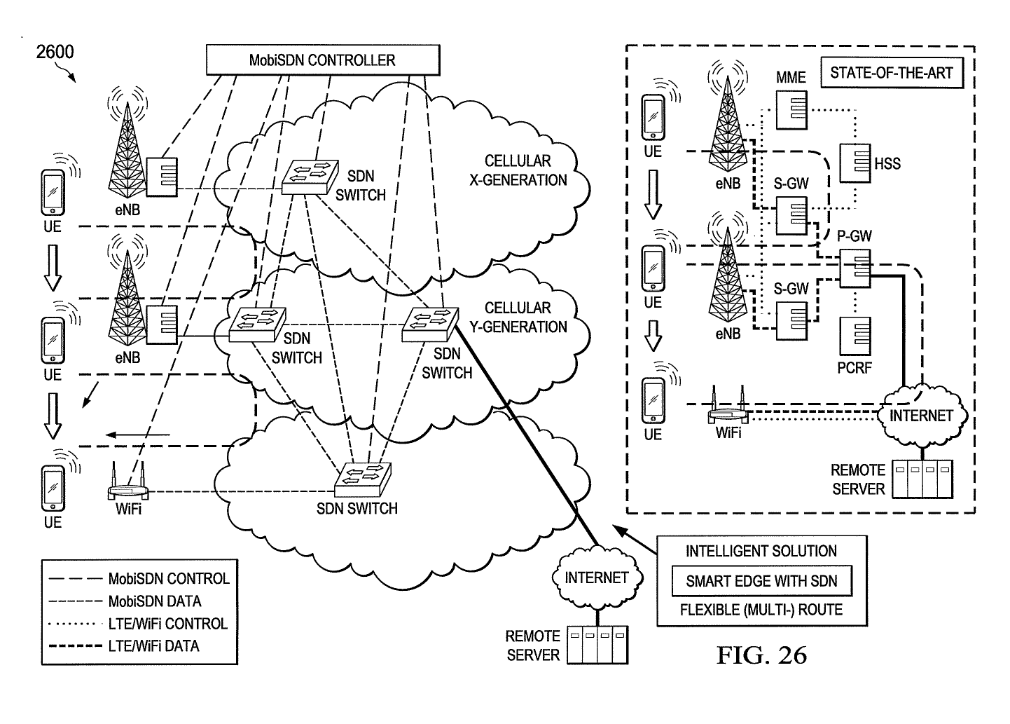

FIG. 26 illustrates a system 2600 using MobiSDN with a UE handover from one eNB to another eNB and a UE handover from eNB to WiFi node via SDN switches according to an embodiment of this disclosure. System 2600 may use a MobiSDN such as MobiSDN 400 as shown in FIG. 4A. The embodiment of the system 2600 shown in FIG. 26 is for illustration only. Other embodiments of the system could be used without departing from the scope of the present disclosure.

One or more embodiments of this disclosure recognize and take into account that ubiquitous connectivity with seamless mobility support is often-stated goal for future mobile networks. Within cellular networks this may involve seamless handover among base stations with different generation access standards and owned by different operators, as well as with other radio access networks, such as WiFi, body area networks, and the like. Some of the challenges include how to provision and guarantee QoS and QoE across different technologies and network architectures. MobiSDN may be beneficial in enhancing QoE by providing intelligent algorithms for associating different traffic and content types with the best link available. For example, streaming video is comprised of different types of packets with different levels of importance at the UE's decoder. The SDN controller for example may ensure that the most critical video packets can be served on the most reliable route, while some less important packets can be served on the less reliable route. This is beneficial depending on the need for load balancing between nodes and user traffic pricing priorities.

In an example embodiment of this disclosure, a UE can handover from one eNB in X-th generation cellular system to another eNB in Y-th generation cellular system, via a short and flexible route. During the handover, content forwarding can be performed from the serving eNB to the targeted eNB, using SDN switches.

In an example embodiment, a UE can handover from one eNB to another radio access technology (RAT) such as WiFi, body area network, etc., via a short and flexible route using SDN, or it can maintain concurrent connections with cellular and other RATs.

When a UE is handing over from one node (eNB or WiFi) to a second node, the first node can forward the content directly to the second node via a SDN switch at the edge. This allows the UE's traffic to stay within the edge of the network, reducing latency core network signaling overhead. In the figure, a UE communicates with a first node. When handover is needed, the serving node (the first node) forwards the content to the target node (a second node) via SDN, and then the UE gets content from the second node.

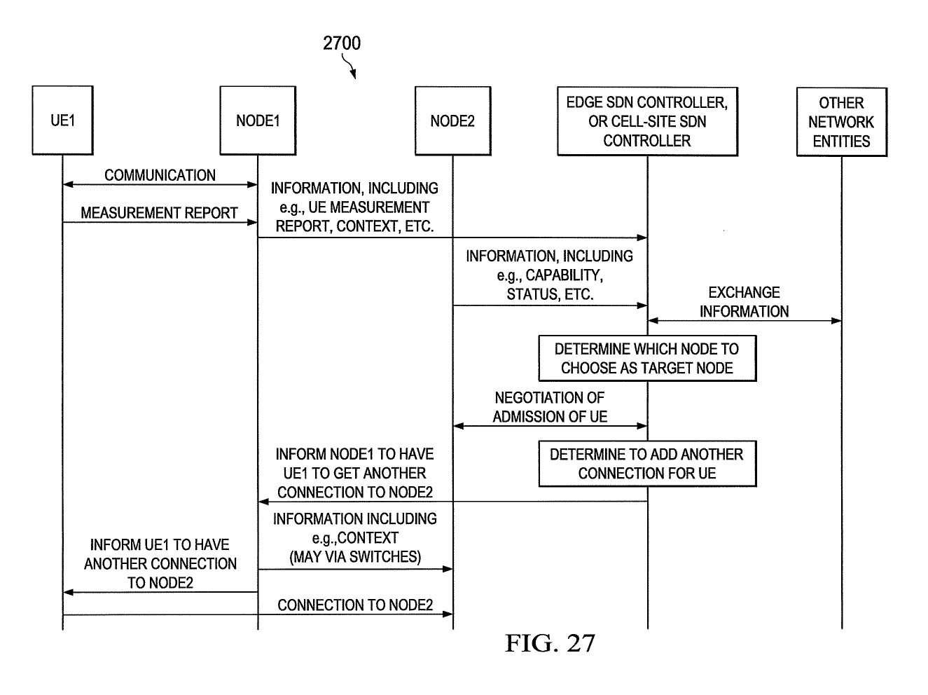

FIG. 27 illustrates a sequence flow 2700 of UE handover from Node1 to Node2 via SDN switches according to an embodiment of this disclosure. Sequence flow 2700 may use a MobiSDN such as MobiSDN 400 as shown in FIG. 4A. The embodiment of the sequence flow 2700 shown in FIG. 27 is for illustration only. Other embodiments of the sequence flow could be used without departing from the scope of the present disclosure.

In an embodiment of this disclosure, UE1 communicates with Node1. UE1 can also send measurement report to Node1. Node1 can communicate with edge SDN controller, or cell-site SDN controller. Node 1 may send information to SDN controller, such as UE measurement report, certain context, etc. The controller can exchange information with other network entities. The controller can also negotiate with other Node (for example Node2), to admit of UE1. The decision of which node that the controller should chose to negotiate can be according to the measurement report from UE, as well as other information, such as capability of node, which node would result in good data forwarding path or route with smaller latency or good throughput, and so on. The controller can negotiate the admission of UE1 with Node2. After negotiation, the controller can determine to add another connection for UE1, or alternatively, it can determine to handover from Node 1 to Node2. The controller can inform Node1 to have UE1 to be connected to Node2. Node1 can send information, such as context, some related content, etc., to Node2, directly or via some switches (data path). If it is via switches, the controller may tell Node1 about the route (where the controller may determine the route for Node 1 to send information to Node2). Node1 can inform UE1 to connect to Node2. Then UE1 can connect to Node2.

In one embodiment, some enabling technologies are considered. In general, one tool to use for smart network is the big data analytics. Content awareness can make a network more efficient. If a UE is driving to a local area, it can receive the local coupons, ads on local events, etc. This is based on the UE's location context. Content can be pre-cached, preloaded to a UE, if the UE's preference is known by the network, where UE's preference may be inferred or learned from UE's history of wireless data usage. Content popularity can be predicted by using, e.g., social media, such as, twitter can be firstly analyzed to get the prediction of the possible coming popular video (because twitter in general is faster than video uploading), then in the video domain, it can use the twitter's prediction to recommend or decide which video to be cached.

To handle big data, naturally our proposed smart network uses smart edge, with distributed processing/computing, distributed file system.

The distributed processing/computing, will support processing/computing sharing among edge servers. For example, for augmented reality, after a UE takes a picture, UE will retrieve the feature and send the feature to the network to get further information. The edge server can first process, or use algorithm to compute, to find (e.g., pattern recognition) the needed information. If one edge server is overloaded in the processing, it can notify the controller, the controller can then ask other edge serves to help with processing. All the edge servers can be a big pool, to provide the processing. Processing/computing can be at the edge, with load balancing, programming transparency.

For distributed file system, for example, it can provide search for the video content. Network controller can include SDN based programmable routing; distributed policy check; middle box friendly. Bases on Hadoop file system, Hadoop MapReduce can be for fast search, distributed storage, cache sharing, content search.

For applications, it can support, for example, super CDN, super visual search, virtualization for value adding services.

In one embodiment, the use of SDN by a mobile device is considered. The mobile device itself may be a component of a MobiSDN. In particular extending SDN to UEs allows new use cases and improved overall network operation.

In a first example, a SDN controller is fully or partially implemented on the UE. In the case of full implementation, all functionality necessary for performing routing, data processing, or other network policy decisions may be performed by the device without assistance from other network entities. In the case of partial implementation, a subset of functions may be implemented and the UE interacts without other network entities (such as eNBs, servers, or other UEs) to perform the desired tasks.

In a second example, SDN enables UE to dynamically connect with multiple RATs on a per-application or per-transport bearer basis. This association decision may be based on multiple metrics including throughput, mobility, security, user context. For example the connectivity controller at the UE may determine whether a given data link should be routed over a cellular network or local area WiFi network depending on whether high throughput or mobility robustness is preferable for the user and taking into account metrics such as radio measurements, higher-layer QoE metrics, and authentication levels provided by the different access networks.

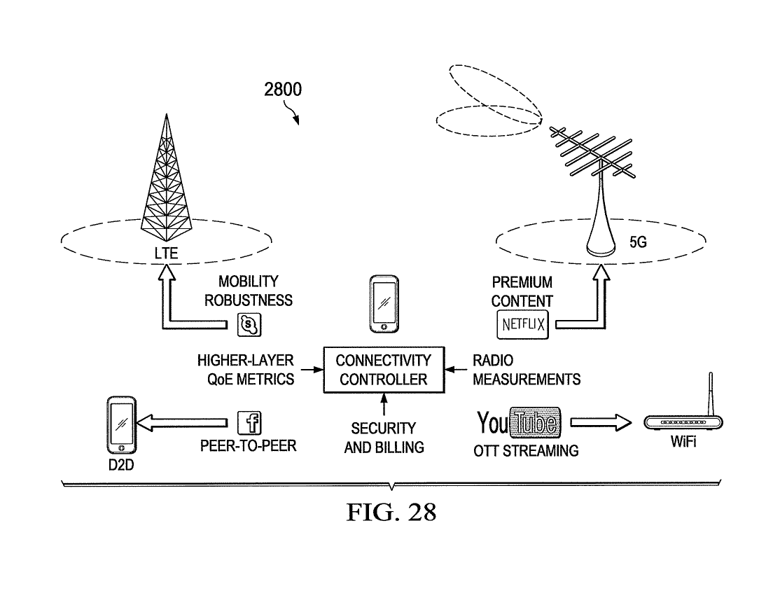

FIG. 28 illustrates a system 2800 of a SDN-based connectivity controller according to an embodiment of this disclosure. The SDN-based connectivity controller determines how different traffic or content types should be served according to various metrics and policies managed at the UE by the controller.

In a third example, the SDN-controller functionality at the UE facilitates the exchange of information related to flow routing between the UE and various network entities. For example, a protocol and related signaling for providing all the necessary information needed for applying the different network may be defined and implemented via SDN controller. Examples of signaling exchange may include:

Content type and priority;

Aggregate throughput UE history and/or per flow;

Application layer QoE/user experience metrics; and

UE context measurements (mobility, location, other UE-based sensors)

Additionally, SDN-based controllers enable flexible sharing and management of radio and processing resources between a UE and other network nodes (include other UEs).

In a fifth example, MobiSDN enabled UEs can implement flow virtualization between multiple UEs by slicing flow space between UEs. Each slice can be used for different apps or services running on those UEs. For example, UEs who have specific apps running can be connected via nearby UEs with the same apps. The benefit of SDN-based flow slicing is that such virtualization supports better QoE and security for those apps.

In a sixth example, MobiSDN UEs may dynamically distribute radio or application processing resources within a network enabling more efficient and effective processing for tasks than could be achieved without resource sharing. For example, real-time analytics can be considered where a device may require processing of data with high bandwidth and low-latency requirements. In the state-of-the-art, devices which do not have this processing capability may be able to offload some or all of the processing to a remote data cloud server. However fundamental network and backhaul delays significantly limit the amount of processing offloading that can be achieved in many scenarios. However a SDN-controller implemented at the UE may choose to offload a portion of the processing to another or multiple other capable entities, including other devices over a direct or network-routed connection, or to a local data processing server located at the edge of the network (for example co-located with the eNB).

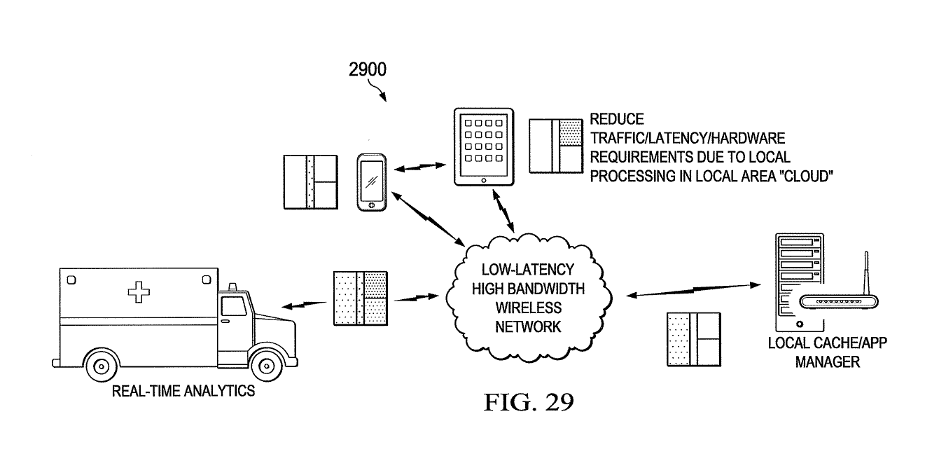

FIG. 29 illustrates a system 2900 of real-time analytics according to an embodiment of this disclosure. System 2900 gives an example of real-time analytics implemented through processing sharing in a local area “cloud” based on a MobiSDN architecture involving UEs and eNBs.

The edge SDN controller, or central SDN controller, can dynamically and adaptively control the resources for wireless backhaul, based on topology, traffic, cell availability, link state, load, and the like.

For the support of Internet of things (IoT), SDN controller at the edge can be used. A service/server layer can be used to handle IoT services, which can be closer to the client comparing to the cloud. This can keep the traffic in the edge as much as possible, not congest the core. It provides lower latency, not to congest the core network, lower cost for networking.

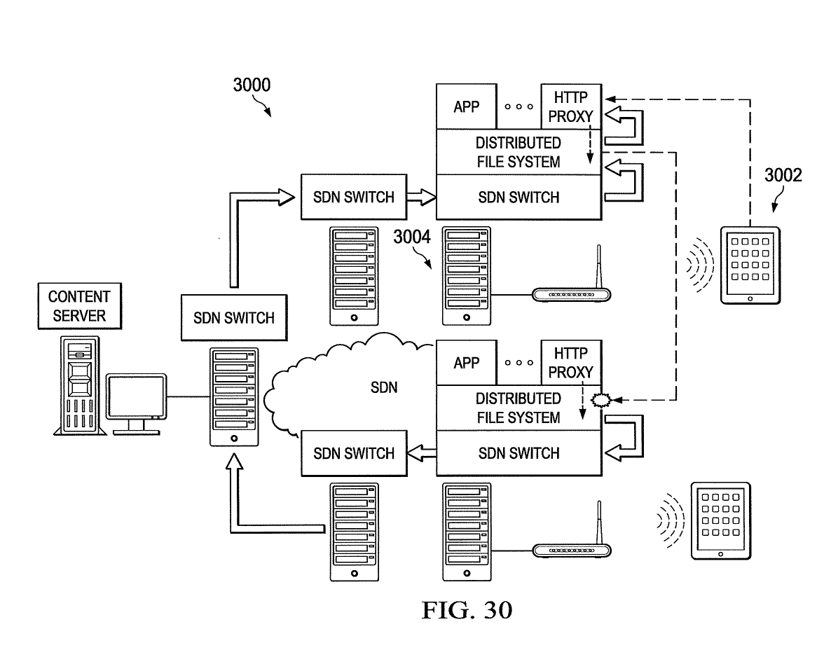

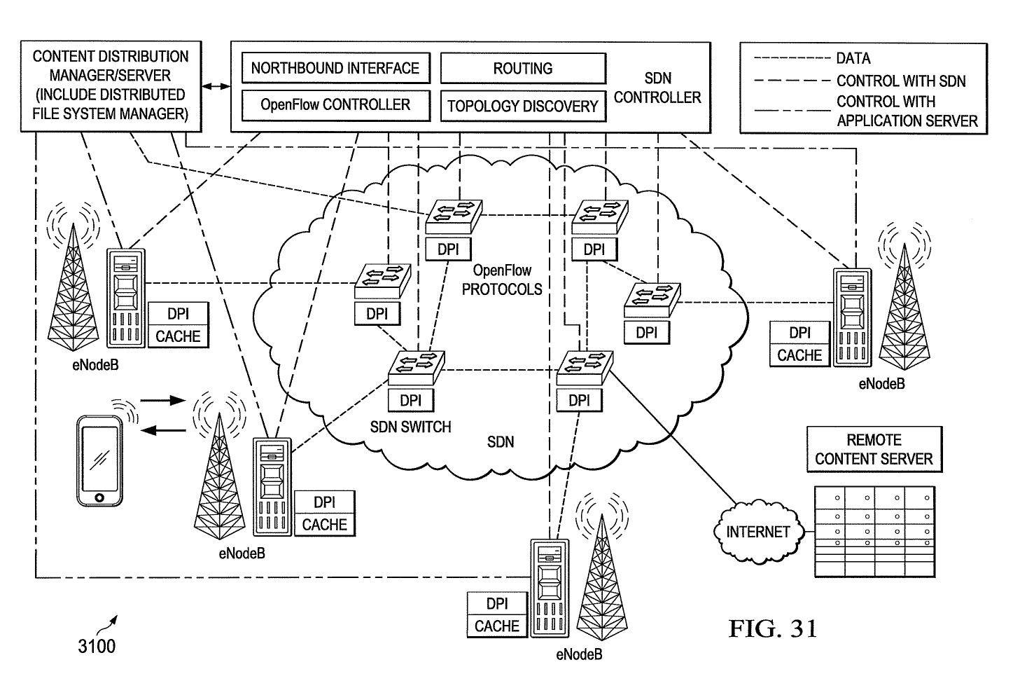

FIG. 30 illustrates a system 3000 for caching with a SDN according to an embodiment of this disclosure. The embodiment of the MobiSDN network in FIG. 31 is for illustration only. Other embodiments of the system could be used without departing from the scope of the present disclosure. In an embodiment, a UE 3002 can send a HTTP request to acquire some content. The local server 3004 at the first node (eNB or WiFi node) can perform a deep inspection of the packet from the UE 3002, and finds out the HTTP request, and local server 3104 understands which content the UE 3002 is requesting. Local server 3104 searches for the content, using a distributed file system. In an embodiment, is may be assumed local server 3004 has the capability of DFS management and SDN controller, for example, the one shown in FIG. 4F. In an embodiment, DFS may be implemented in a way that each node (e.g., each server at the cellsite of an eNB) may know the whole file system incorporating all the other servers, or DFS may be implemented in a way that only the application server or the edge controller may know the file system incorporating all the other servers located at the sites of eNBs. If it finds out that the content is in the other server, the SDN controller can then figure out the best route to deliver the content to the UE 3002. For example, the controller determines that the best route can be that the second node (eNB or WiFi node) should pass the content by the switches using the data forwarding, then the content can be forwarded to the first node. Then the first node can provide content to the UE. The content does not need to be provided from remote content server in the Internet.

FIG. 31 illustrates a system 3100 for caching with a SDN according to an embodiment of this disclosure. The embodiment of the MobiSDN network in FIG. 31 is for illustration only. Other embodiments of the system could be used without departing from the scope of the present disclosure. In an embodiment, content distribution manager/server in the data plane can be connected to SDN switches and eNBs (cellsite servers), and in the control plane it can be connected to SDN controller (such as central controller, edge controller, and the like), and eNBs (cellsite servers). The content distribution manager/server can include distributed file system (DFS) manager. The content distribution manager/server can be called by other names such as Content Delivery Network/Content Distribution Network Manager, etc. An eNB (with cellsite server) may be equipped with local cache. An eNB may have SDN capability where the eNB may include SDN switch or SDN switch functions. If an eNB does not include SDN switch or SDN switch functions, the eNB may not connect to the SDN controller in the control plane, rather, the eNB can be connected with a SDN switch and the switch is connected to the SDN controller in the control plane. SDN switch is equipped with DPI. Assuming that DFS knows where the content requested is. UE sends a request to an eNB. The eNB forwards the request to a request SDN switch. SDN switch forwards the request to the SDN controller. The SDN controller captures the request, performs DPI, and consults with DFS to find which eNB server has the content. Alternatively, the eNB server can perform the DPI, and it can intercept the UE's request. If the local cache has the content, the eNB can provide content to the UE. If not, the eNB can forward the request to SDN controller, and the SDN controller can consult DFS to find which node (content source node) has the content. The SDN controller determines the best path/route between the source SDN switch (source eNB connected) and request SDN switch. The SDN controller tells the requesting SDN switch to forward the request to the source server via SDN switches. The source server sends the content via path/route determined by the SDN controller. In the figure, OpenFlow is used as an example of SDN protocol.

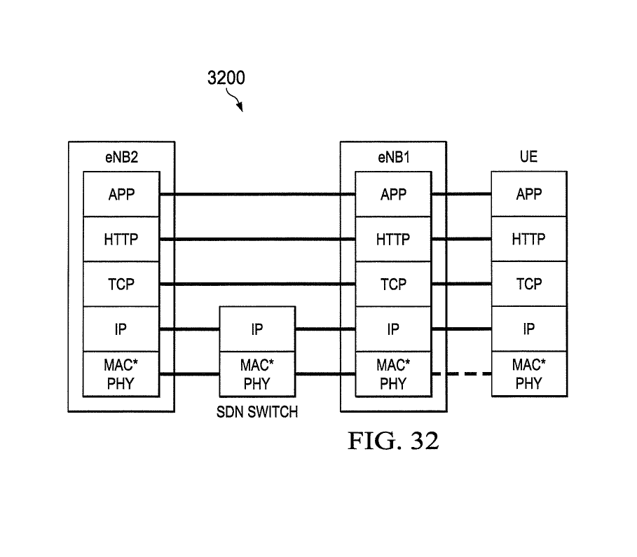

FIG. 32 illustrates a protocol stack 3200 according to an embodiment of this disclosure. The protocol stack 3200 illustrates which layers are represented at each network device.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus, comprising:
a memory element; and
a controller coupled to the memory element in a mobile software defined network, the controller configured to:
receive control information related to a source node and a target node from a plurality of network devices in the software defined network;
identify a route for data forwarding between the source node and the target node based on the control information; and
request data forwarding to the plurality of network devices according to the route,
wherein the source node or the target node can be at least one of a user equipment (UE), and a cellsite node comprising a base station.

2. The apparatus of claim 1, wherein the route comprises only one or more cellsite nodes.

3. The apparatus of claim 1, wherein the route comprises only a combination of one or more cellsite nodes and one or more software defined network switches.

4. The apparatus of claim 1, wherein identifying the route for the data forwarding between the source node and the target node based on the control information comprises the controller configured to:
communicate with one or more a combination of one or more cellsite nodes and one or more software defined network switches to identify a path with a lowest latency.

5. The apparatus of claim 1, wherein requesting the data forwarding to the plurality of network devices according to the route comprises the controller configured to:
requesting a base station to admit the target node.

6. A cellsite node in a software defined network, comprising:
a base station;
a cellsite server coupled to the base station; and
a controller coupled to the cellsite server, the controller configured to:
receive data packets from a source node;
perform deep packet inspection on the data packets to identify control information;
send the control information to an edge controller in the software defined network;
receive routing information from the edge controller; and
forward the data packets based on the routing information.

7. The cellsite node of claim 6, wherein the cellsite node forwards the data packets to one of a switch and another cellsite node.

8. The cellsite node of claim 6, wherein the base station sends a message to the source node to perform a handover to another base station.

9. The cellsite node of claim 7, wherein the switch forwards the data packets to a WiFi node.

10. The cellsite node of claim 6, wherein the base station forwards the data packets to a target node.

11. A method for managing data in a software defined network, the method comprising:
receiving control information related to a source node and a target node from a plurality of network devices in the software defined network;
identifying a route for data forwarding between the source node and the target node based on the control information; and
requesting data forwarding to the plurality of network devices according to the route,
wherein the source node or the target node can be at least one of a user equipment (UE), and a cellsite node comprising a base station.

12. The method of claim 11, wherein the route comprises only one or more cellsite nodes.

13. The method of claim 11, wherein the route comprises only a combination of one or more cellsite nodes and one or more software defined network switches.

14. The method of claim 11, wherein identifying the route for the data forwarding between the source node and the target node based on the control information comprises:
communicate with one or more a combination of one or more cellsite nodes and one or more software defined network switches to identify a path with a lowest latency.

15. The method of claim 11, wherein sending the route to the plurality of network devices comprises:
sending a message to a base station to admit the target node.

16. A method for managing data in a software defined network, the method comprising:
receiving data packets from a source node;
performing deep packet inspection on the data packets to identify control information;
sending the control information to an edge controller in the software defined network;
receiving routing information from the edge controller; and
forwarding the data packets based on the routing information.

17. The method of claim 16, further comprising:
forwarding the data packets to one of a switch and a cellsite node.

18. The method of claim 16, further comprising:
sending a message to the source node to perform a handover to a cellsite node.

19. The method of claim 17, wherein the switch forwards the data packets to a WiFi node.

20. The method of claim 16, further comprising:
forwarding the data packets to a target node.
